(19) United States
(12) Patent Application Publication
(10) Pub. No.: US 2014/0365446 A1
(43) Pub. Date: Dec. 11, 2014

(54) VERIFICATION SYSTEM, VERIFICATION METHOD, AND MEDIUM STORING VERIFICATION PROGRAM

(71) Applicant: FUJITSU LIMITED, Kawasaki-shi (JP)

(72) Inventors: Taichi Sugiyama, Kawasaki (JP); Takeshi Yasuie, Kawasaki (JP); Yuji Nomura, Kawasaki (JP)

(73) Assignee: FUJITSU LIMITED, Kawasaki-shi (JP)

(21) Appl. No.: 14/286,161

(22) Filed: May 23, 2014

(30) Foreign Application Priority Data
Jun. 10, 2013 (JP) 2013-122155

(51) Int. Cl. G06F 17/30

(52) U.S. Cl. CPC G06F 17/30371
USPC 707/687

(57) ABSTRACT

A verification system include: a server that receives each of a first data group and second data group, and transmits a third data group and a fourth data group to respond to each of the first data group and second data group received; a database server that receives the third data group and transmits the second data group; and a verification device that performs operation verification of the server or database server, the verification device including a processor configured to transmit, to the database server, a partial data group in the third data group received by the database server, and transmit, to the server, the first data group corresponding to another data group in the third data group, thereby supplying the other data group to the database server and using the first data group, the partial data group, and the fourth data group, to perform the operation verification.

### CROSS-REFERENCE TO RELATED APPLICATION

This application is based upon and claims the benefit of priority of the prior Japanese Patent Application No. 2013-122155, filed on Jun. 10, 2013, the entire contents of which are incorporated herein by reference.

### FIELD

The embodiments discussed herein are related to a verification system, verification method, and medium storing a verification program.

### BACKGROUND

A system has been proposed in which multiple devices are mutually linked to execute data processing. This system has a client terminal, first device, and second device, for example. Note that the first device is an application server, for example, and the second device is a database server (hereinafter called “database”), for example.

The first device executes an application corresponding to a first request received from the client terminal, and transmits, to the second device, a second request corresponding to the first request. Upon receiving the second request, the second device responds to the second request and transmits a first response to the first device. Upon receiving the first response, the first device executes an application corresponding to the first response, and transmits, to the client terminal, a second response corresponding to the first response.

Note that this system may have various types of devices between the client terminal and the first device, examples of which include a load balancer, a network switch, and so forth.

Let us assume a case in which performance degradation has occurred in this system. In this case, the system administrator (hereinafter called “administrator”) performs operation verification as to this system, and identifies the cause of the performance degradation. As a method for identifying the cause, the number of the first devices (also called scale out) is increased so as to determine whether or not a data processing bottleneck has occurred in the system due to the first devices.

In the case of thus executing a scale-out method, there is a demand for a technique for evaluating the effectiveness of such a scale-out method for determining the scaling-out level in a short time and at low cost. For example, in order to scale out the first device, not only installing of additional first devices, but also additional setting for various kinds of devices such as the load balancer has to be performed, which is troublesome.

The above-described related art is disclosed in Japanese Laid-open Patent Publication Nos. 2010-081194 and 2011-141774, for example.

In order to solve such a problem, the administrator virtually creates a state wherein a particular device (for example, an application server) is scaled out, by reducing the load for each device to be scaled out. For example, a verification device configured to verify the system operation thins out, by a predetermined ratio, the request packets that request processing as to the device to be scaled out.

However, if the request packets are thinned out to reduce the load in this system, such a reduction in the load affects a device (for example, database) provided downstream of the device to be scaled out. For example, such a reduction in the load reduces the amount of processing to be performed by the database. This leads to a reduction in the overall amount of processing to be performed by the system. Description will be made with reference to FIGS. 1 and 2 regarding a specific example of the effect. Thus, such a verification device may not be capable of providing appropriate operation verification.

### SUMMARY

According to an aspect of the invention, a verification system include: a server that receives each of a first data group and second data group, and transmits a third data group and a fourth data group to respond to each of the first data group and second data group received; a database server that receives the third data group and transmits the second data group; and a verification device that performs operation verification of the server or database server, the verification device including a processor configured to transmit, to the database server, a partial data group in the third data group received by the database server, and transmit, to the server, the first data group corresponding to another data group in the third data group, thereby supplying the other data group to the database server and using the first data group, the partial data group, and the fourth data group, to perform the operation verification.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a first sequence diagram schematically illustrating a process relating to an embodiment;

FIG. 2 is an example of a second sequence diagram schematically illustrating a process relating to an embodiment;

FIG. 3 is an example diagram describing an overall system of an embodiment;

FIG. 4 is an example hardware block diagram of the verification device in FIG. 3;

FIG. 5 is an example block diagram of software modules which the verification device in FIG. 4 executes;

FIG. 6 is an example sequence diagram schematically describing the flow of transmission/reception processing of a message in an active environment;

FIG. 7 is an example diagram illustrating a state in which content of a message that is captured by an active packet capturing unit is stored in a table format;

FIG. 8 is an example table illustrating the correlation of an HTTP request, an SQL request corresponding to the HTTP request, an SQL response corresponding to the SQL request, and an HTTP response corresponding to the SQL response;

FIG. 9 is an example method describing the flow of processing that stores a correcting processing method corresponding to a thinning-out request message;

FIG. 10 is an example method describing the flow of verification processing, which the verification device executes, in a verification environment;

FIG. 11 is an example sequence diagram schematically describing the flow of transmission/reception processing of a message in the verification environment;

FIG. 12 is an example of a diagram illustrating a state in which content of a message that is captured by a verification performing unit is stored in a table format;

FIG. 13 is an example method describing the flow of display processing of verification results;

FIG. 14 is an example sequence diagram schematically describing the flow of transmission/reception processing of a message in the active environment;

FIG. 15 is an example diagram illustrating a state in which content of a message that is captured by the actual packet capturing unit is stored in a table format;

FIG. 16 is an example table illustrating the correlation of an HTTP request, an SQL request corresponding to the HTTP request, an SQL response corresponding to the SQL request, and an HTTP response corresponding to the SQL response;

FIG. 17 is an example sequence diagram schematically describing the flow of transmission/reception processing of a message in the verification environment;

FIG. 18 is an example of a diagram illustrating a state in which content of a message that is captured by the verification performing unit is stored in a table format;

FIG. 19 is an example diagram describing an overall system according to another embodiment;

FIG. 20 is an example block diagram of a software module that the verification device in FIG. 19 executes;

FIG. 21 is an example method describing the flow of transmission/reception processing of a message in the verification environment, which a client virtual packet transmitting/receiving unit executes;

FIG. 22 is an example method describing the flow of transmission/reception processing of a message in the verification environment, which a client virtual packet transmitting/receiving unit executes;

FIG. 23 is an example sequence diagram schematically describing the flow of transmission/reception processing of a message in the verification environment; and

FIG. 24 is an example of a diagram illustrating a state in which contents of a message that is captured by the verification performing unit are stored in a table format.

### DESCRIPTION OF EMBODIMENTS

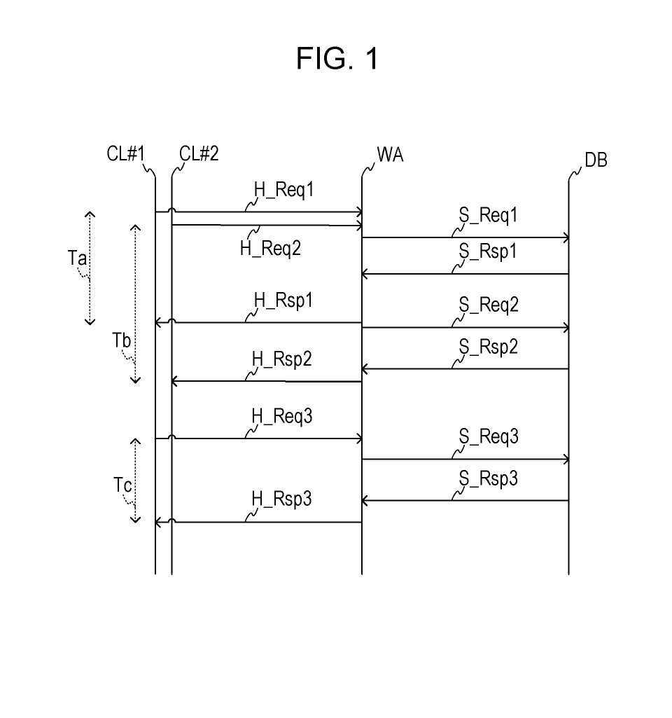

FIG. 1 is an example of a first sequence diagram schematically illustrating a process relating to an embodiment. In the description of the sequence diagrams below, the flow of time is indicated from top to bottom of FIG. 1, and arrows in the left and right directions indicate the transmission direction of a message. The message is a communication packet, for example. In the description of the diagrams below, similar elements will be denoted by the same reference numerals, and redundant description will be omitted.

A system relating to the present embodiment has a client terminal CL#1, client terminal CL#2, application server WA, and database DB. Hereinafter, the application server will be called AP server. The flow of message transmitting/receiving processing will be described with reference to FIG. 1.

The client terminal CL#1 transmits a first HTTP request 1 to the AP server WA, as indicated by a reference symbol H_Req1. Next, the client terminal CL#2 transmits a second HTTP request 2 to the AP server WA, as indicated by the reference symbol H_Req2.

Upon receiving the first HTTP request 1, the AP server WA responds to the received first HTTP request 1, and transmits a first SQL request 1 to a database DB, as indicated by a reference symbol S_Req1. The database DB transmits a first SQL response 1, which is a response as to the first SQL request, to the AP server WA, as indicated by a reference symbol S_Rsp1. Note that SQL is an acronym for Structured Query Language.

Upon receiving the first SQL response 1, the AP server WA responds to the received first SQL response 1, and transmits a first HTTP response 1 to the client terminal CL#1, as indicated by a reference symbol H_Rsp1.

After transmitting the first HTTP response 1 as indicated by reference symbol H_Rsp1, the AP server WA responds to the second HTTP request 2 (see reference symbol H_Req2), and transmits a second SQL request 2 to the database DB, as indicated by the reference symbol S_Req2. The database DB transmits a second SQL response 2, which is a response as to the second SQL request 2, to the AP server WA, as indicated by the reference symbol S_Rsp2. Upon receiving the second SQL response 2, the AP server WA responds to the received second SQL response 2, and transmits a second HTTP response 2 to the client terminal CL#2, as indicated by the reference symbol H_Rsp2.

Finally, the client terminal CL#1 transmits a third HTTP request 3 to the AP server WA, as indicated by a reference symbol H_Req3. Upon receiving the third HTTP request 3, the AP server WA responds to the received third HTTP request 3, and transmits a third SQL request 3 to the database DB, as indicated by a reference symbol S_Req3. The database DB transmits a third SQL response 3, which is a response as to the third SQL request 3, to the AP server WA, as indicated by a reference symbol S_Rsp3. Upon receiving the third SQL response 3, the AP server WA responds to the received third SQL response 3, and transmits a third HTTP response 3 to the client terminal CL#1, as indicated by a reference symbol H_Rsp3.

Now, a reference symbol Ta indicates a first response time from when the client terminal CL#1 transmits the first HTTP request 1 until receiving the first HTTP response 1. A reference symbol Tb indicates a second response time from when the client terminal CL#2 transmits the second HTTP request 2 until receiving the second HTTP response 2. A reference symbol Tc indicates a third response time from when the client terminal CL#1 transmits the third HTTP request 3 until receiving the third HTTP response 3.

Now, the AP server WA sequentially receives the first HTTP request 1 and second HTTP request 2, and transmits the first SQL request 1 and second SQL request 2 to the database DB. This leads to an increase in processing load on the AP server WA, resulting in a delay of the start time at which the AP server WA transmits the second SQL request 2 to the database DB. This leads to a delay of the time at which the second HTTP response 2 reaches the client terminal CL#2. In other words, the second response time Tb is longer than the first response time Ta.

Thus, if the AP server WA receives multiple requests simultaneously, in some cases, a bottleneck of the data processing occurs in the system due to the AP server WA. Thus, in order to resolve the bottleneck, the system administrator scales out the AP server WA (increases the number of AP servers WA). For example, the AP server WA may be scaled out from one unit to two units.

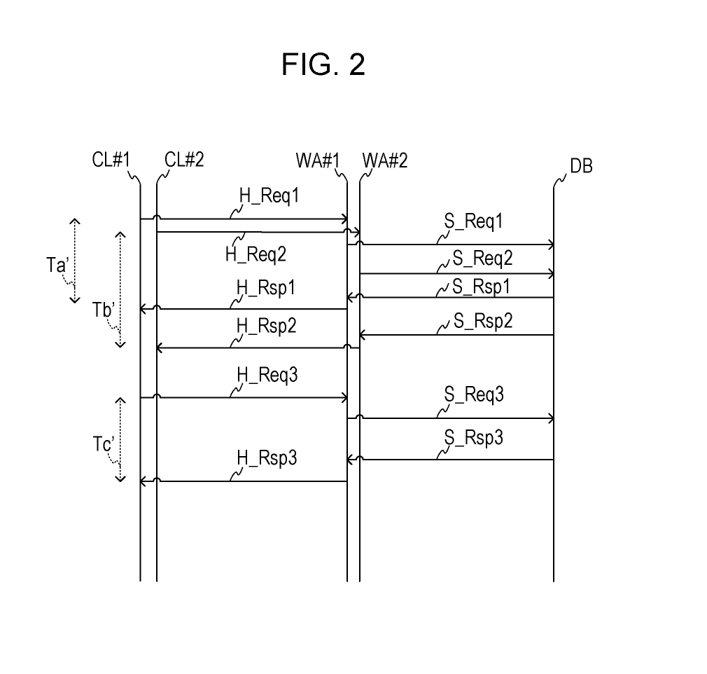

FIG. 2 is a second example sequence diagram schematically illustrating a process relating to the present embodiment. FIG. 2 illustrates a state in which the AP server WA is scaled out from the single AP server WA shown in FIG. 1 to two AP servers WA#1 and WA#2.

Note that a load balancer is provided between the client terminals CL#1 and CL#2, and between the AP servers WA#1 and WA#2. Upon receiving the first HTTP request 1 from the client terminal CL#1 and the third HTTP request 3 from the client terminal CL#1, the load balancer transmits the first HTTP request 1 and third HTTP request 3 to the AP server WA#1. Also, for example, upon receiving the second HTTP request 2 from the client terminal CL#2, the load balancer transmits the second HTTP request 2 to the AP server WA#2.

As indicated by the reference symbol H_Req1, the first HTTP request 1 from the client terminal CL#1 is transmitted to the AP server WA#1, and as indicated by the reference symbol H_Req2, the second HTTP request 2 from the client terminal CL#2 is transmitted to the AP server WA#2.

Upon receiving the first HTTP request 1, the AP server WA#1 responds to the received first HTTP request 1, and transmits the first SQL request 1 to the database DB as indicated by the reference symbol S_Req1. Also, upon receiving the second HTTP request 2, the AP server WA#2 responds to the received second HTTP request 2, and transmits the second SQL request 2 to the database DB as indicated by the reference symbol S_Req2.

The database DB transmits the first SQL response 1, which is the response to the first SQL request 1, to the AP server WA#1, as indicated by the reference symbol S_Rsp1. Upon receiving the first SQL response 1, the AP server WA#1 responds to the received first SQL response 1, and transmits the first HTTP response 1 to the client terminal CL#1, as indicated by the reference symbol H_Rsp1.

The database DB transmits the second SQL response 2, which is the response to the second SQL request 2, to the AP server WA#2, as indicated by the reference symbol S_Rsp2. Upon receiving the second SQL response 2, the AP server WA#2 responds to the received second SQL response 2, and transmits the second HTTP response 2 to the client terminal CL#2, as indicated by the reference symbol H_Rsp2.

Note that the reference symbols H_Req3, S_Req3, S_Rsp3, and H_Rsp3 are the same as in FIG. 1, so description of these reference symbols will be omitted.

A first response time Ta′ in FIG. 2 is shorter than the first response time Ta in FIG. 1, and a second response time Tb′ in FIG. 2 is shorter than the second response time Tb in FIG. 1. That is to say, a shorter processing time is achieved by the scale out as described with reference to FIG. 2.

Even when a bottleneck of system operation occurs due to the AP server WA as described with reference to FIG. 1, the operation time can be reduced by scaling out the AP server WA, as described with reference to FIG. 2. In other words, such a scaling out of the AP server WA may be effectively employed as a bottleneck solving method.

However, when a bottleneck has occurred in the system operation due to the database DB, scaling out of the AP server WA may not solve such a bottleneck problem. In other words, such a scaling out is not effectively employable as a bottleneck solving method.

Thus, it is difficult to identify the cause of degradation of the performance of the information processing service provided by the system, that is, the device (location) where the bottleneck has occurred. Also, even if the device where the bottleneck has occurred is identified, it is difficult to estimate the number of devices to be increased in the scaling out.

Furthermore, in order to perform device scaling out, settings have to be adjusted for the load balancer provided upstream from this device according to the scaling out. Otherwise, it is difficult to judge whether or not this scaling out is effective.

Thus, for example, instead of actually scaling out the device, let us assume an operation wherein a device is virtually scaled out in order to provide appropriate operation verification.

For example, let us assume the system described with reference to FIG. 1 (hereinafter called “the first system”), and a system further including a verification device in addition to the configuration of the first system (hereinafter called “the second system”).

The verification device in the second system operates so that the AP server WA does not receive the second HTTP request 2 (reference symbol H_Req2) transmitted from the client terminal CL#2. In other words, the verification device thins out the second HTTP request 2.

As a result, the verification device provides the second system with a virtual scaled-out state in which a single application server is virtually increased to two application servers.

However, such a simple method in which only the HTTP requests are thinned out has a problem in that such thinned out HTTP requests affect the device (database) provided downstream of the device (application server) to be scaled out in the second system. For example, the database DB does not receive the SQL request corresponding to the thinned out HTTP request, and does not execute the processing corresponding to the SQL request thereof.

That is to say, the database DB has a problem in that a part of the SQL requests is not processed in the database DB. As a result, the data stored in the database DB in the first system does not match the data stored in the database DB in the second system. Thus, no judgment may be made based on data matching between the databases DB in the two systems whether or not the databases in the two systems have executed the same processing.

That is to say, an SQL request that is not processed in the database DB may occur in the second system. Consequently, the content of the database DB in the first system and the content of the database DB in the second system do not match each other, inhibiting the two databases DB from comparing content with each other and verifying whether both databases DB have executed the same processing.

Also, the number of SQL requests that the database DB processes in the second system may also decrease. Therefore, the load of the database DB in the second system is lightened as compared to the load of the database DB in the first system. Consequently, the overall processing load in the second system becomes lighter as compared to the overall processing load of the first system, whereby it may be difficult to appropriately estimate the scope of the device to be scaled out.

A verification device will be described below, which instead of actually scaling out the device, creates a virtual state in which the device is scaled out, and appropriate operation verification is performed.

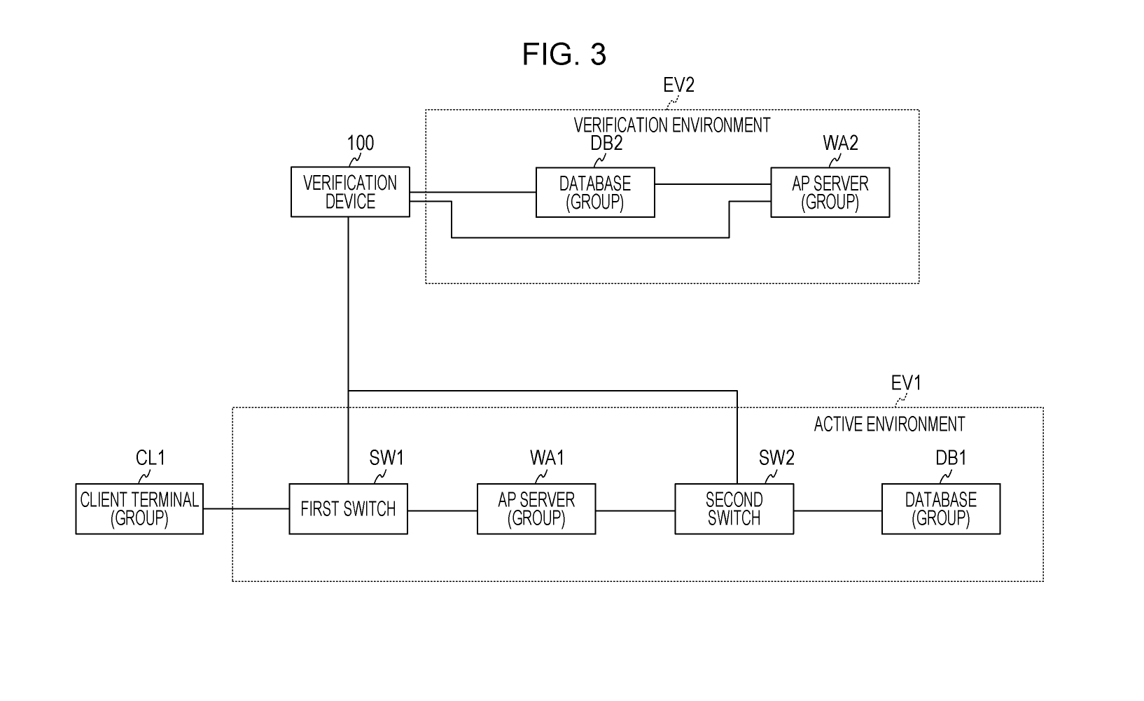

FIG. 3 is an example diagram describing an overall system of an embodiment. A verification device 100 is connected to an active environment EV1 and a verification environment EV2. The active environment EV1 and verification environment EV2 are separate networks. The entire system (also called verification system) is an example of a system in which multiple devices (for example, servers or databases) are mutually linked, and data processing is executed.

The active environment EV1 receives the request from the client (group) CL1 and responds to the client (group) CL1 with this request. In other words, the active environment EV1 provides a Web service to the client. The verification environment EV2 is an environment to identify the cause of performance degradation in the case that performance degradation occurs in the active environment EV1.

The active environment EV1 has a first switch SW1, AP server (group) WA1, second switch SW2, and database (group) DB1. Hereinafter, the notation of (group) will be omitted.

The first switch SW1 is connected to the client terminal CL1, the AP server WA1, and the verification device 100, via a port. The first switch SW1 is a relay device that switches a message that is transmitted/received between the client terminal CL1 and the AP server WA1. The first switch SW1 performs port mirroring, and transmits the message that is transmitted/received between the client terminal CL1 and the AP server WA1 to the verification device 100. Note that a switching hub, router, or the like may be used as the first switch SW1.

The AP server WA1 is a server that receives a request from the client terminal CL1 and executes transactions as to the database DB1, and may include one or multiple application servers.

The database DB1 has a database function, and executes updating of the database and the like in response to requests received from the AP server WA1. The data base DB1 then transmits the results of having executed the received requests to the AP server WA1. The database DB1 includes one or multiple databases.

The second switch SW2 is connected to the AP server WA1, database DB1, and the verification device 100, via a port. The second switch SW2 is a relay device that switches a message that is transmitted/received between the AP server WA1 and the database DB1. The second switch SW2 performs port mirroring, and transmits the message that is transmitted/received between the AP server WA1 and the database DB1 to the verification device 100. Note that a switching hub, router, or the like may be used as the second switch SW2.

The client terminal CL1 uses a Web browser or the like to access the AP server WA1 and use various types of services that the AP server WA1 provides. The client terminal CL1 includes one or multiple client terminals.

A client terminal in the client terminal CL1 transmits an HTTP request to an application server in the AP server WA1. This application server executes an application corresponding to the received HTTP request, and transmits an SQL request corresponding to the HTTP request to one of the database DBs in the database DB1.

Upon receiving the SQL request, this database DB responds to the SQL request and transmits an SQL response to the aforementioned one application server. Upon receiving the SQL response, the aforementioned application server executes the application corresponding to the SQL response, and transmits an HTTP response corresponding to the SQL request to the aforementioned one client terminal.

Note that upon receiving a request message such as an SQL request or the like that is transmitted from a device, the database DB extracts a transmission source IP address from the header information of the message. The transmission source IP address is an IP address that is preset in the aforementioned device. The database DB then responds to this message and transmits a response message such as an SQL response or the like to the aforementioned device. The IP address preset in the aforementioned device is included in the response message as a destination address.

The active environment EV2 has an AP server WA2 and database DB2. The AP server WA2 is a server having the same functions as the AP server WA1. For example, the AP server WA2 and AP server WA1 may both have the same one application server or multiple application servers. Similarly, for example, the database DB2 and database DB1 may both have the same one database DB server or multiple database DB servers.

The verification device 100 is connected to the first switch SW1 and second switch SW2 in the active environment EV1 and the database DB2 and AP server WA2 in the verification environment EV2, and identifies the cause of performance degradation of the active environment EV1. In this identification, the verification device 100 creates a state wherein the number of application servers in the AP server WA2 is virtually scaled out. In this virtually scaled out state, the verification device 100 determines whether or not scaling out the number of application servers in order to improve performance degradation is valid.

Note that there may be cases wherein the active environment EV1 has an unillustrated load balancer provided between the first switch SW1 and AP server WA1, or between the second switch SW2 and the database DB1. The load balancer distributes (also called allocating) received messages (also called requests) to downstream devices, based on various methods.

Examples of the methods include a static distribution method, dynamic distribution method, URL base load distribution method, and HTTP header load distribution method. An example of a static distribution method may be a round-robin method wherein requests are evenly distributed to downstream devices. An example of a dynamic distribution method may be a minimal connection method wherein requests are distributed so that the number of connections of the downstream devices are even. An example of a URL base load distribution method may be a method to determine the host names included in the requests and distribute to the server groups. Also, an example of an HTTP header load distribution method may be a method to distribute the requests with a User agent header that is included in the HTTP request.

Hardware Block Diagram

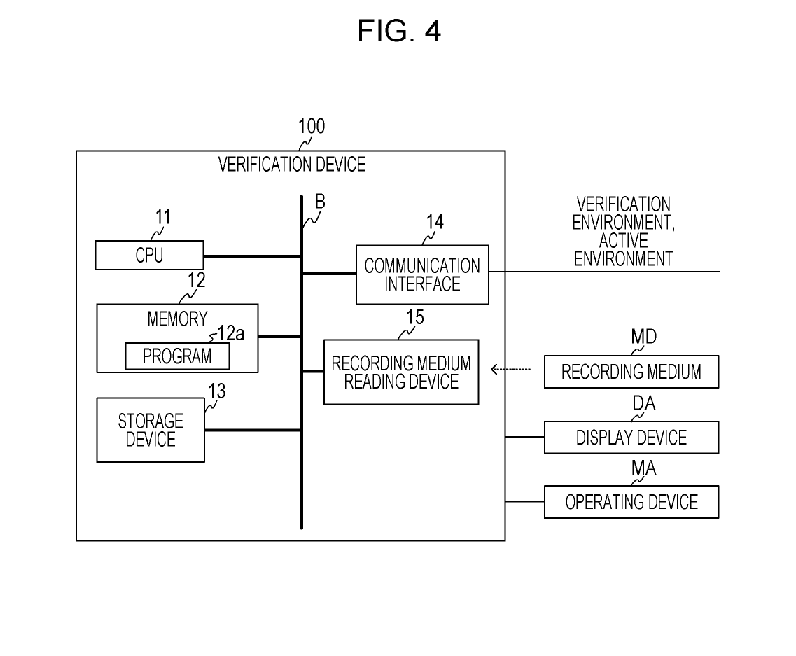

FIG. 4 is an example of a hardware block diagram of the verification device 100 in FIG. 3. The verification device 100 has a Central Processing Unit (CPU) 11, memory 12, storage device 13, communication interface 14, and recording medium reading device 15, which are mutually connected via a bus B, for example.

The CPU 11 is a computer (control unit) that controls the entire verification device 100. The memory 12 temporarily stores data, which has been processed by the various types of information processing that the CPU 11 executes, and various types of programs. Also, at the time of start-up, the CPU 11 reads out a program that is stored beforehand in the storage device 13, and loads this in the memory 12 as a program 12a.

The storage device 13 may be a magnetic-storage device such as a hard disk drive (HDD) or a non-volatile memory. Additionally, a program that will be described with reference to FIG. 4 may be stored beforehand in the storage device 13.

The communication interface 14 is a device that provides an interface function that performs communication processing by the first switch SW1, second switch SW2, database DB2, and AP server WA2.

In the case that the verification device 100 includes a cabled communication function, for example, the communication interface 14 may be a so-called Network Interface Card (NIC). Also, in the case that the verification device 100 includes a wireless communication function, the communication interface 14 may be a wireless LAN terminal, for example.

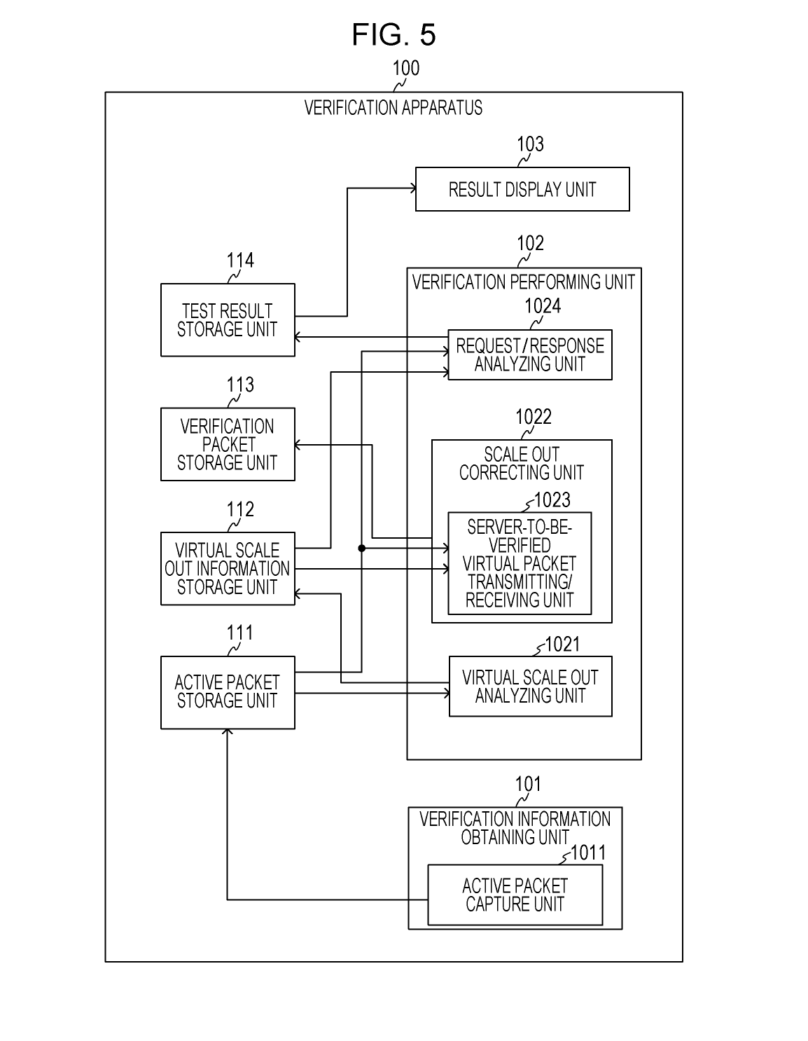

The recording medium reading device 15 is a device to read out the data recorded on a recording medium MD. The recording medium MD may be a portable recording medium such as a Compact Disc Read Only Memory (CD-ROM), Digital Versatile Disc (DVD), Universal Serial Bus (USB) memory, or the like. A program that will be described with reference to FIG. 5 may be stored beforehand in the recording medium MD.

A display device DA is a device that has a display function such as a liquid crystal display or the like. An operating device MA is a device to operate the verification device 100, and for example may be a keyboard, mouse, or the like.

Block Diagram of Software Modules

FIG. 5 is an example block diagram of software modules that the verification device 100 in FIG. 4 executes. The verification device 100 has a verification information obtaining unit 101, verification performing unit 102, result displaying unit 103, active packet storage unit 111, virtual scale out information storage unit 112, verification packet storage unit 113, and test result storage unit 114.

The verification information obtaining unit 101, verification performing unit 102, and result displaying unit 103 are so-called programs. These programs may be stored in the storage device 13, for example. Note that these programs may also be stored in the storage medium MD.

At the time of startup, the CPU 11 in FIG. 4 reads out these programs from the storage device 13 and loads them into the memory 12 as program 12a, thereby causing these programs to function as software modules.

The active packet storage unit 111, virtual scale out information storage unit 112, and verification packet storage unit 113 schematically illustrate functions of a storage device (a storage) 13.

The verification information obtaining unit 101 has an active packet capturing unit 1011. The verification performing unit 102 has a virtual scale out analyzing unit 1021, scale out correcting unit 1022, server-to-be-verified virtual packet transmitting/receiving unit 1023, and request/response analysis unit 1024.

The verification information obtaining unit 101 obtains various types of information used for verifying the operations of the active environment EV1. The active packet capturing unit 1011 receives a message transmitted from the first switch SW1 and second switch SW2, and stores the content of the message in the active packet storage unit 111 in a table format.

The verification performing unit 102 performs (also called executing) operation verification. The virtual scale out analyzing unit 1021 analyzes in the verification environment EV2 how to thin out a message for virtually scaling out a server to be verified. In the case of thinning out a message, the scale out correcting unit 1022 performs various types of correcting processing so as not to affect the operation verification. The server-to-be-verified virtual packet transmitting/receiving unit 1023, performs processing to virtually execute the operations of the server to be verified.

The request/response analyzing unit 1024 analyzes the request message and response message that are transmitted/received in the verification environment EV2. The result display unit 103 displays the results of the operation verification.

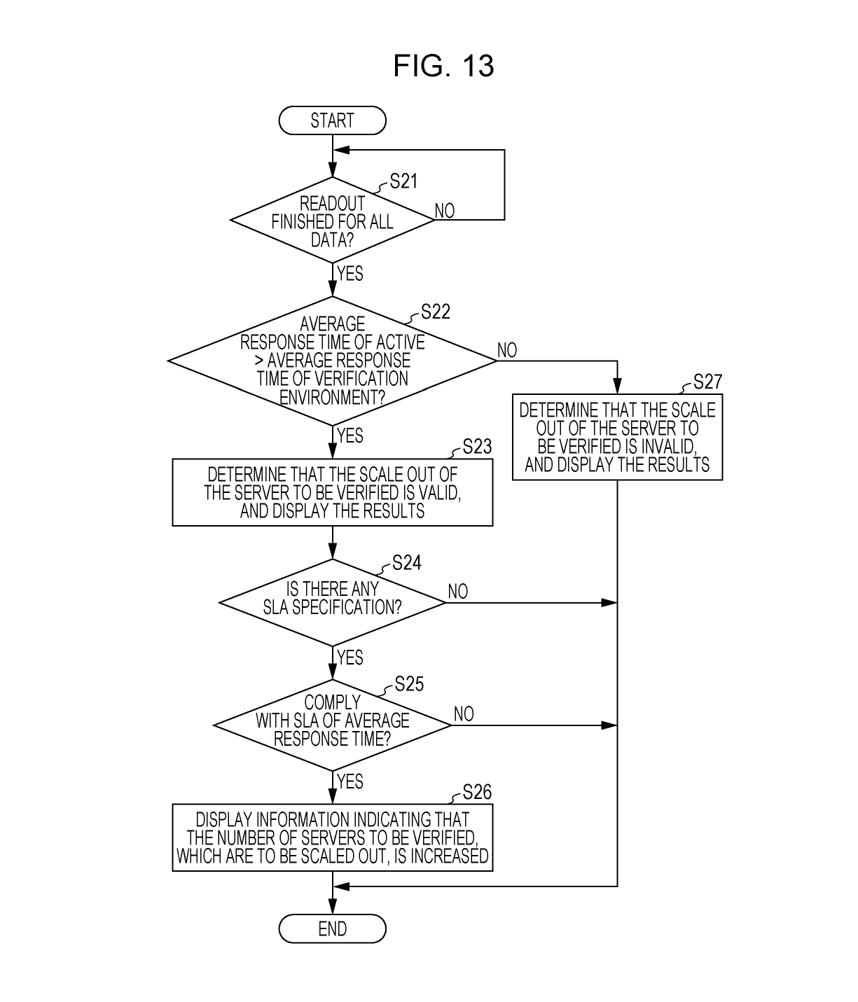

The active packet storage unit 111 stores messages that have been transmitted/received in the active environment EV1, in a table format. The virtual scale out information storage unit 112 stores messages that are to be thinned out. The verification packet storage unit 113 stores the messages that have been transmitted/received in the verification environment EV2, in a table format. The test result storage unit 114 stores the average active response time and the average verification response time. The average active response time and average verification response time will be described with reference to FIG. 13.

Transmitting/Receiving Messages in Active Environment

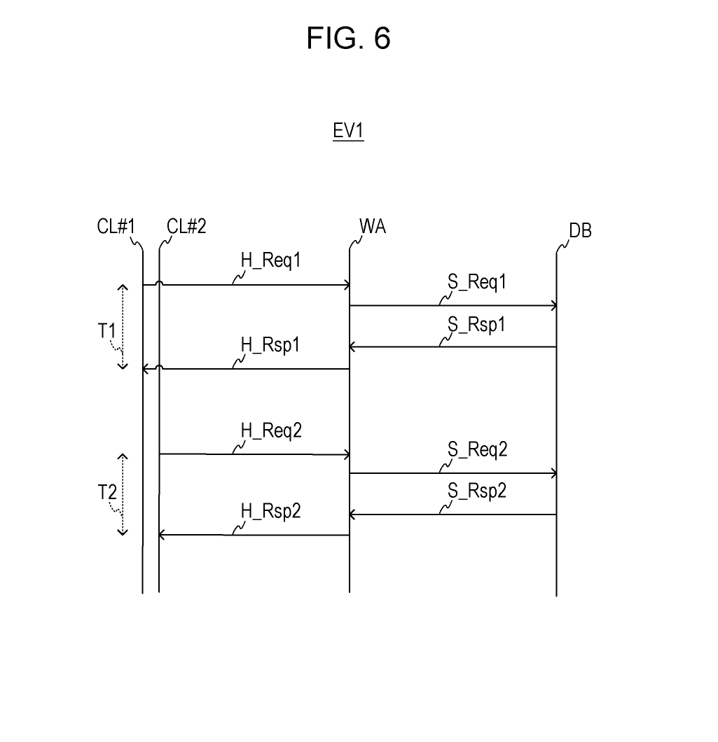

An example of transmission/reception processing of a message in the active environment EV1 will be described with reference to FIG. 6. FIG. 6 is an example sequence diagram to schematically describe the flow of transmission/reception processing of messages in the active environment EV1. Note that reference symbols T1 and T2 will be described with reference to FIG. 13. The verification device 100 references the transmission/reception processing of a message in the active environment EV1 and executes operation verification.

Hereinafter, one of the client terminals in the client terminal CL1 will be referenced as client terminal CL#1. A client terminal in the client terminal CL1 that is different from the CL#1 will be referenced as client terminal CL#2. One of the application servers in the AP server WA1 will be referenced as AP server WA, and one of the databases in the database DB1 will be referenced as database DB.

The client terminal CL#1 transmits a first HTTP request 1 to the AP server WA, as indicated by the reference symbol H_Req1. Upon receiving the first HTTP request 1, the AP server WA responds to the received first HTTP request 1, and transmits a first SQL request 1 to the database DB, as indicated by the reference symbol S_Req1. The database DB then transmits a first SQL response 1 which is the response to the first SQL request 1 to the AP server WA, as indicated by the reference symbol S_Rsp1. Upon receiving the first SQL response 1, the AP server WA responds to the received first SQL response 1, and transmits a first HTTP response 1 to the client terminal CL#1, as indicated by the reference symbol H_Rsp1.

The client terminal CL#2 transmits a second HTTP request 2 to the AP server WA, as indicated by the reference symbol H_Req2. Upon receiving the second HTTP request 2, the AP server WA responds to the received second HTTP request 2, and transmits a second SQL request 2 to the database DB, as indicated by the reference symbol S_Req2. The database DB then transmits a second SQL response 1 which is the response to the second SQL request 2 to the AP server WA, as indicated by the reference symbol S_Rsp2. Upon receiving the second SQL response 2, the AP server WA responds to the received second SQL response 2, and transmits a second HTTP response 2 to the client terminal CL#2, as indicated by the reference symbol H_Rsp2.

Message Capturing Processing in Active Environment

The capturing processing of a message in the active environment EV1 in FIG. 3 will be described with reference to FIGS. 3, 6, and 7. The first switch SW1 in FIG. 3 transmits a message that has been transmitted/received between the client terminal CL#1, client terminal CL#2, and AP server WA, to the verification device 100. Similarly, the second switch SW2 transmits a message that has been transmitted/received between the AP server WA and database DB to the verification device 100. The active packet capturing unit 1011 of the verification device 100 receives the message transmitted from the first switch SW1 and the second switch SW2 and stores the content of the message in the active packet storage unit 111 in a table format. Hereinafter, the processing wherein the active packet capturing unit 1011 receives and stores the messages transmitted from the first switch SW1 and the second switch SW2 will be reference as “capturing”, as appropriate.

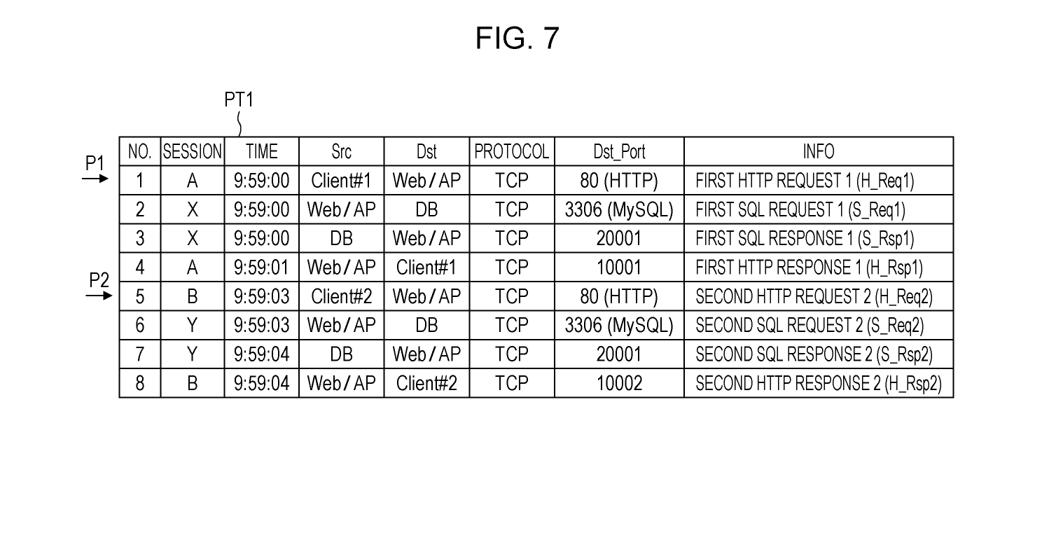

FIG. 7 is an example diagram illustrating a state in which content of a message that the active packet capturing unit 1011 has captured is stored in a table format. The active packet capturing unit 1011 captures the message that has been transmitted/receive in the active environment EV1 of FIG. 3, and stores this in a packet storage table PT1 in a time-series format. In the example in FIG. 7, the active packet capturing unit 1011 captures the messages transmitted/received between the client terminal and AP server WA, and further between the AP server WA and database DB, which is described in the sequence diagram in FIG. 6, and stores these in the packet storage table PT1 in a time-series format.

The packet storage table PT1 includes a No. column, Session column, Time column, Src column, Dst column, Protocol column, Dst_Port column, and Info column. Information relating to one unit of a captured message is stored in one row in the packet storage table PT1.

The No. column is a column that stores the order of captured messages in a time-series format. The Session column is a column that stores session identifiers which identify the unit of communication (also called session) executed between devices that transmit/receive messages, from the time that connection is established until the connection is disconnected. The Time column is a column that stores the time at which the message is captured.

The Src column is a column that stores identifying information indicating the transmission source of a captured message (SOURCE). The Dst column is a column that stores identifying information indicating the transmission destination of a captured message (DESTINATION). Client#1 and Client#2 as stored in the Src column and Dst column reference one client terminal CL#1 and one client terminal CL#2, respectively. Web/AP and DB as stored in the Src column and Dst column reference one AP server and one database, respectively.

The Protocol column is a column that stores the protocol used between the transmission source device and transmission destination device when transmitting/receiving the captured message. TCP is stored in every row of the Protocol column.

The Dst_Port column is a column that stores a port number that the device at the transmission destination of the captured message uses. For example, 80(HTTP) indicates a port number of 80 for HTTP use. Also, 3306(MySQL) indicates a port number of 3306 for MySQL use.

The Info column is a column that schematically stores information indicating the content of the captured message. The content within parentheses in the Info column indicates the reference symbols indicating the transmitted/received messages in FIG. 6. The content within parentheses in the Info column is written here for ease of description, and is not stored in the active packet capturing unit 1011.

The packet storage table PT1 in FIG. 7 indicates a state wherein the active packet capturing unit 1011 has captured the messages transmitted/received between the client terminal CL#1, client terminal CL#2, and AP server WA, and between the AP server WA and database DB, as described with reference to FIG. 6.

Description will be given of the processing to store message content in a table format, in a case where the active packet capturing unit 1011 captures the first HTTP request 1 which is a message indicated by the reference symbol H_Req1 described with reference to FIG. 6. The active packet capturing unit 1011 first stores a 1 in the No. column.

In the row where a 1 is stored in the No. column, the active packet capturing unit 1011 stores an A in the Session column, stores time 9:59:00, which is when the first HTTP request 1 is captured, in the Time column, stores the identifying information, Client#1, which indicates the transmission source of the first HTTP request 1, in the Src column, and stores the identifying information, Web/AP, which indicates the transmission destination of the first HTTP request 1, in the Dst column. The active packet capturing unit 1011 stores TCP in the Protocol column, stores 80(HTTP) in the Dst_Prt column, and stores First HTTP request 1 in the Info column.

Now, the first HTTP request 1 is a request message to request the database, for example, to transmit data fulfilling a certain search criteria, to the client terminal. The first SQL request 1 corresponding to the first HTTP request 1 is a request message that includes an SQL command specifying execution of this request. The first SQL response 1 that responds to the first SQL request 1 is a response message that includes data to fulfill the aforementioned predetermined search criteria. The first HTTP response 1 is a response message including HTML data after the application server has converted the data included in the SQL response message to the Hyper Text Markup Language (HTML) format.

The second HTTP request 2 is a request message to request the database, for example, to update the first data to the second data. The second SQL request 2 corresponding to the second HTTP request 2 is a request message that includes an SQL command specifying this update. The second SQL response 2 which responds to the second SQL request 2 is a response message that includes update result data indicating the success or failure of the update. The second HTTP response 2 is a response message that includes HTML data after the application server has converted the update result data included in the SQL response message to the HTML format.

The Info column stores the message content of the above-described first HTTP request 1, first SQL request 1, first SQL response 1, first HTTP response 1, second HTTP request 2, second SQL request 2, second SQL response 2, and second HTTP response 2.

Correlation Table

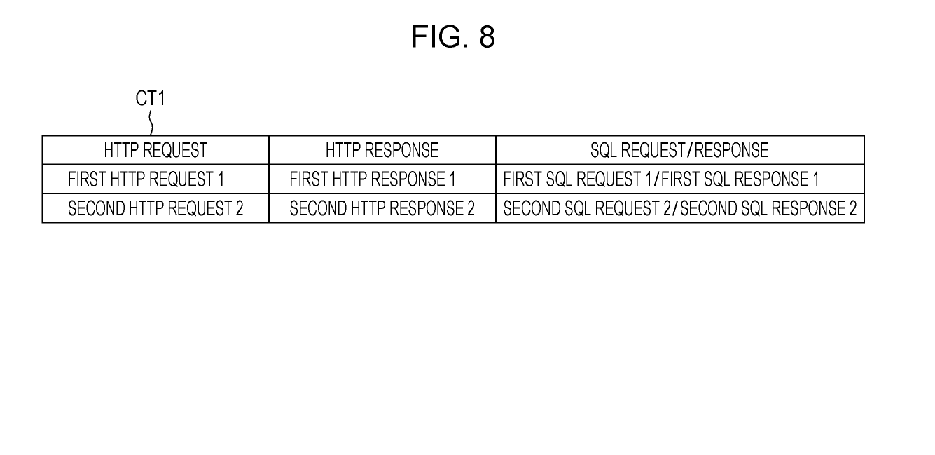

FIG. 8 is an example of a table indicating the correlation between a HTTP request, a SQL request corresponding to this HTTP request, a SQL response corresponding to this SQL request, and an HTTP response corresponding to this SQL response. For example, the system administrator may analyze the content of the packet storage table PT1, create a correlation table CT1, and store this beforehand in the storage device 13.

The correlation table CT1 includes an HTTP request column, HTTP response column, and SQL request-SQL response column. The correlation table CT1 stores an HTTP request, an SQL request corresponding to this HTTP request, an SQL response corresponding to this SQL request, and an HTTP response corresponding to this SQL response, in one row of the correlation table.

The correlation table CT1 stores the first HTTP request 1 (see reference symbol H_Req1 in FIG. 6), first HTTP response 1 (see reference symbol H_Rsp 1 in FIG. 6), first SQL request 1—first SQL response 1 (see reference symbols S_Req1 and S_Rsp1 in FIG. 6), in the second row thereof, for example.

The virtual scale out analyzing unit 1021 selects a thinning out request message, that is, an HTTP request to thin out, based on FIGS. 7 and 8. The virtual scale out analyzing unit 1021 then stores a message that is to be transmitted in place of the thinning out HTTP request, based on FIG. 8. In other words, the virtual scale out analyzing unit 1021 stores a correction processing method corresponding to the thinning out request message, based on FIGS. 7 and 8.

Correction Processing Method Corresponding to Thinning Out Request Message

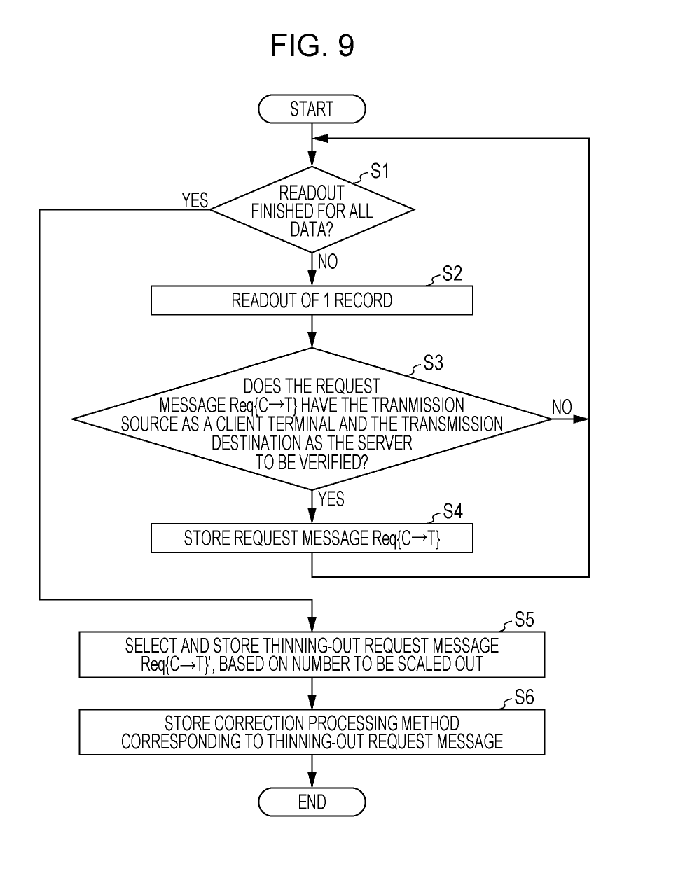

FIG. 9 is a method example that describes the flow of processing to store the correction processing method corresponding to the thinning-out request message.

Operation S1: The virtual scale out analyzing unit 1021 determines whether the readout of all the data stored in the active packet storage unit 111 has ended. In the case that readout has not ended for all the data (No in operation S1), the flow is advanced to operation S2. Specifically, the virtual scale out analyzing unit 1021 determines whether or not all of the records in the storage table PT1 in FIG. 7 have been read out. The term “record” here means information relating to one message unit stored in one row of the packet storage table PT1.

Operation S2: The virtual scale out analyzing unit 1021 reads out the records stored in the active packet storage unit 111, one row at a time. Specifically, the virtual scale out analyzing unit 1021 reads out one record at a time, in ascending order of storage in the No. column in the packet storage table PT1 in FIG. 7 first.

Operation S3: The virtual scale out analyzing unit 1021 determines whether the one record that is read out has the transmission source thereof as the client terminal and whether or not the transmission destination corresponds to the request message Req{C→T}, which is the server to be verified. The “C” in the brackets { } indicates a client terminal, and the “T” in the brackets { } indicates the server to be verified. The arrow (→) in the brackets { } indicate the message transmission direction. The server to be verified is a server to be subjected to scale out, and may be an AP server, for example.

In the case that the one record read out does not correspond to the request message Req{C→T}, where the transmission source thereof as the client terminal and the transmission destination is the server to be verified (No in operation S3), the flow is returned to operation S1. In the case that the one record read out corresponds to the request message Req{C→T}, the transmission source thereof is the client terminal and the transmission destination where the server to be verified is (Yes in operation S3), the flow is advanced to operation S4.

Operation S4: The virtual scale out analyzing unit 1021 stores the request message Req{C→T} in the storage device 13, and the flow is returned to operation S1.

In the case that the readout of all the data has ended (Yes in operation S1), the flow is advanced to operation S5.

Operation S5: The virtual scale out analyzing unit 1021 selects the request message Req{C→T}′ to be thinned out from the request messages Req{C→T} stored in the storage device 13 during operation S4, based on the number of servers to be verified that are to be scaled out, and stores this in the virtual scale out information storage unit 112.

Operation S6: The virtual scale out analyzing unit 1021 stores a correcting processing method corresponding to the thinning out request message Req{C→T}. Specifically, the virtual scale out analyzing unit 1021 references the corresponding table, identifies a message that is to be transmitted to the database DB in place of the request message Req{C→T} to be thinned out, and stores the identified message in the virtual scale out information storage unit 112.

Verification Processing in Verification Environment

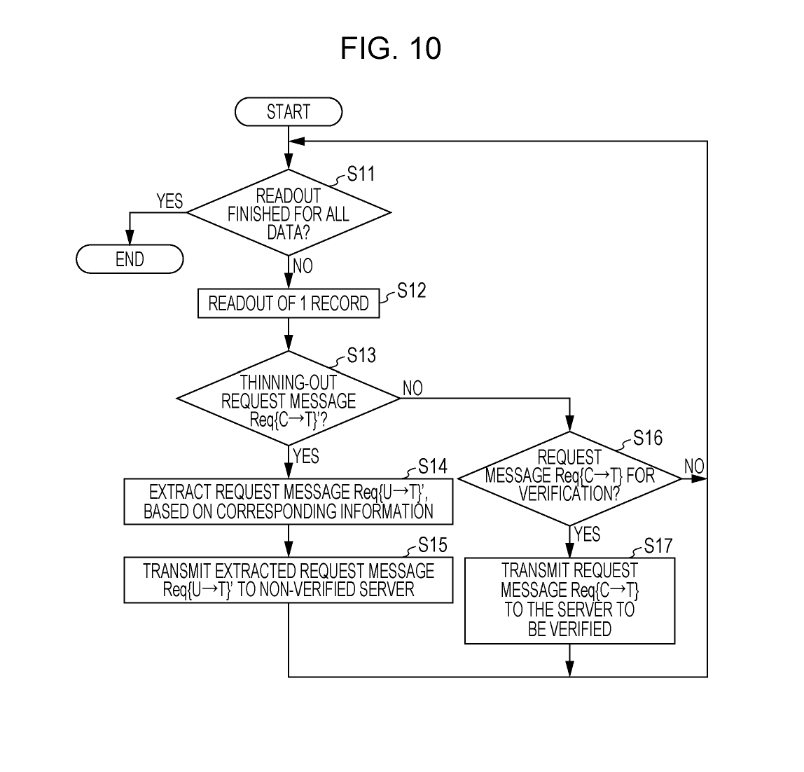

The verification processing that the verification device 100 executes in the verification environment EV2 will be described with reference to FIGS. 7 and 10. FIG. 10 is an example method to describe the flow of verification processing that the verification device 100 executes in the verification environment EV2.

Operation S11: The server-to-be-verified virtual packet transmitting/receiving unit 1023 determines whether the readout of all of the data stored in the active packet storage unit 111 has ended. In the case that readout for all of the data has ended (Yes in operation S11), the processing is ended. In the case that readout has not ended for all the data (No in operation S11), the flow is advanced to operation S12. Specifically, the server-to-be-verified virtual packet transmitting/receiving unit 1023 determines whether or not all of the records in the packet storage table PT1 in FIG. 7 have been read out.

Operation S12: The server-to-be-verified virtual packet transmitting/receiving unit 1023 reads out the records stored in the active packet storage unit 111, one row at a time. Specifically, the server-to-be-verified virtual packet transmitting/receiving unit 1023 reads out one record at a time in ascending order of storage in the No. column in the packet storage table PT1 in FIG. 7 first.

Operation S13: The server-to-be-verified virtual packet transmitting/receiving unit 1023 determines whether the one record that is read out corresponds to the thinning out request message Req{C→T}′. The thinning out request message Req{C→T}′ is a request message that the verification scale out analyzing unit 1021 has stored in the virtual scale out information storage unit 112 in operation S5 in FIG. 9. In the case that the one record that is read out corresponds to the thinning out request message Req{C→T}′ (Yes in operation S13), the flow is advanced to operation S14.

Operation S14: The server-to-be-verified virtual packet transmitting/receiving unit 1023 extracts a request message Req{U→T}′, which is to be transmitted to the non-verified server in place of the thinning out message Req{C→T}′, from the virtual scale out information storage unit 112. The “U” in the brackets { } indicates a non-verified server. In the description below, the non-verified server may be a database, for example.

The request message Req{U→T}′ is a message that is identified as the message that the virtual scale out analyzing unit 1021 will transmit to the database DB instead of the thinning out request message Req{C→T}′ in operation S6.

Operation S15: The server-to-be-verified virtual packet transmitting/receiving unit 1023 transmits the message extracted in operation S14 to a non-verified server on the verification environment EV2. In other words, the server-to-be-verified virtual packet transmitting/receiving unit 1023 transmits the message extracted in operation S14 to the non-verified server as a request message from the server to be verified in the verification environment EV2 to the non-verified server in the verification environment EV2.

The server to be verified in the verification environment EV2 is one of the AP servers in the AP server WA2 in the example in FIG. 3. The non-verified server in the verification environment EV2 is one of the databases in the database DB2 in the example in FIG. 3. Upon operation S15 ending, the flow is returned to operation S11.

In the case that the one record read out in operation S13 is not applicable to the thinning out request message Req{C→T}′ (No in operation S13), the flow is advanced to operation S16.

Operation S16: The server-to-be-verified virtual packet transmitting/receiving unit 1023 determines whether or not the one record read out in operation S12 corresponds to the request message Req{C→T} for verification that has been transmitted from the client terminal to the server to be verified. In the case that the one record read out in operation S12 is not applicable to the request message Req{C→T} for verification that has been transmitted from the client terminal to the server to be verified (No in operation S16), the flow is returned to operation S11. In the case that the one record read out in operation S12 corresponds to the request message Req{C→T} for verification that has been transmitted from the client terminal to the server to be verified (No in operation S16), the flow is advanced to operation S17.

Operation S17: The server-to-be-verified virtual packet transmitting/receiving unit 1023 transmits the request message for verification Req{C→T} to the server to be verified. Upon ending operation S17, the flow is returned to operation S11.

The server-to-be-verified virtual packet transmitting/receiving unit 1023 reads out the record in operation S12 in accordance with the point-in-time information stored in the Time column which is included in the message to be read out.

In the example in FIG. 7, the server-to-be-verified virtual packet transmitting/receiving unit 1023 reads out the records 1 through 3 in the No. column one record at a time, in the time that one second passes from the point-in-time Ts (for example, 9:59:00) of starting to execute operation S12 for the first time, and executes the processing in operation S13 and thereafter. At the point-in-time when one second has passed from the starting point-in-time Ts (for example, 9:59:01), the server-to-be-verified virtual packet transmitting/receiving unit 1023 reads out the one record that is record 4 in the No. column, and executes the processing in operation S13 and thereafter. Next, in the time from 3 seconds (for example, 9:59:03) to 4 seconds from the starting point-in-time Ts, the server-to-be-verified virtual packet transmitting/receiving unit 1023 reads out the records 5 and 6 in the No. column one record at a time, and executes the processing in operation S13 and thereafter. Finally, in the time from 4 seconds (for example, 9:59:04) to 5 seconds from the starting point-in-time Ts, the server-to-be-verified virtual packet transmitting/receiving unit 1023 reads out the records 7 and 8 in the No. column one record at a time, and executes the processing in operation S13 and thereafter.

Processing to store the correction processing method corresponding to the thinning out request message described with reference to FIG. 9 will be described in detail, with reference to FIGS. 7 through 9. In the description hereinafter, the server to be verified is an application server.

The virtual scale out analyzing unit 1021 reads out one record at a time in the order of smaller numbers stored in the No. column in the packet storage table PT1 in FIG. 7 (operation S2). The virtual scale out analyzing unit 1021 then determines whether or not a client terminal is included as information that identifies the transmission source in the one record that is read out, and whether or not the server to be verified (Web/AP in FIG. 7) is included as information that identifies the transmission destination in this one record (operation S3).

The client terminal is the Client #1 or Client #2 in FIG. 7, and the server to be verified is the Web/AP in FIG. 7.

Now, the virtual scale out analyzing unit 1021 first reads out the record in session number 1, which is indicated by the reference symbol P1 in FIG. 7, from the packet storage table PT1. The record indicated by the reference symbol P1 in FIG. 7 includes the client terminal (Client#1) as information to identify the transmission source, and includes the server to be verified (Web/AP) as information to identify the transmission destination for this one record. Accordingly, the virtual scale out analyzing unit 1021 makes the determination of Yes in operation S3, and stores the record indicated by the reference symbol P1, which is the request message Req{C→T}, in the storage device 13 (operation S4).

The virtual scale out analyzing unit 1021 repeats the operations S1 through S4, and further reads out the records in session number 2 through session number 4 in ascending order of storage in the No. column in the packet storage table PT1 in FIG. 7, one record at a time (operation S2). The records in session number 2 through session number 4 do not include the client terminal as information to identify the transmission source (SRC) nor the server to be verified as information to identify the transmission destination (DST). Accordingly, the virtual scale out analyzing unit 1021 consistently makes the determination of No for the records in session number 2 through session number 4, in the determination in operation S3, and does not execute the processing in operation S4. Next, the virtual scale out analyzing unit 1021 reads out the record in session number 5 as indicated by the reference symbol P2.

The record in session number 5 includes the client terminal (client#2) as information that identifies the transmission source, and includes the server to be verified (Web/AP) as information that identifies the transmission destination in this one record. Accordingly, the virtual scale out analyzing unit 1021 makes the determination of Yes in operation S3, and stores the record indicated by the reference symbol P2, which is the request message Req{C→T}, in the storage device 13 (operation S4).

The virtual scale out analyzing unit 1021 repeats the operations S1 through S4, and further reads out the records in session number 6 through session number 8 in ascending order of storage in the No. column in the packet storage table PT1 in FIG. 7, one record at a time (operation S2). The records in session number 6 through session number 8 do not include the client terminal as information to identify the transmission source nor the server to be verified as information to identify the transmission destination. Accordingly, the virtual scale out analyzing unit 1021 consistently makes the determination of No for the records in session number 6 through session number 8, in the determination in operation S3, and does not execute the processing in operation S4.

Upon the virtual scale out analyzing unit 1021 ending the readout of the record in session number 8, that is, upon the readout of all the records in the packet storage table PT1 in FIG. 7 ending (Yes in operation S1), the flow is advanced to Operation S5.

Now, let us say that the number of application servers in the AP server WA1 that is actually set in the active environment EV1 is Sb units. Also, let us say that the number of application servers in the case of scaling out the application server in the AP server WA1, that is, in the case of assuming that the application server of the AP server WA1 is scaled out, is Sa units. That is to say, the number of application servers is assumed to increase from Sb to Sa in the scale out. The administrator inputs the Sa and Sb into the verification device 100 via the operation device MA illustrated in FIG. 4.

Also, let us say that the number of request messages Req{C→T} stored in operation S4 by the stored device 13 are Rn messages.

The virtual scale out analyzing unit 1021 executes Expression (1), and computes Rd, which is the number of thinning out request messages Req{C→T}′ from the request messages Req{C→T} that the storage device 13 has stored.

Rd=((Sa−Sb)/Sa)×Rn Expression (1)

Note that in the case that Rd is not an integer, round down or out to integer.

For example, let us say that Sa is 2 and Sb is 1. Let us also say that the request messages Req{C→T} that the storage device 13 has stored are the two records indicated by reference symbols P1 and P2 in FIG. 7. That is to say, Rn is 2.

In this case, Rd=1(((2−1)/2)×2). Accordingly, the virtual scale out analyzing unit 1021 selects one request message Req{C→T}. That is to say, the virtual scale out analyzing unit 1021 selects one of the two records indicated by reference symbols P1 and P2 in FIG. 7. The virtual scale out analyzing unit 1021 selects the one record indicated by the reference symbol P2 in FIG. 7, for example, and stores this in the virtual scale out information storage unit 112 (operation S5). Hereinafter, the selection processing in operation S5 of the request messages Req{C→T} that the storage device 13 has stored will be called the selection process for request messages Req{C→T} as appropriate.

The virtual scale out analyzing unit 1021 stores a message to be transmitted to the non-verified server (for example, the database DB) in place of the one record selected in operation S5 (that is, thinning out HTTP request), based on FIG. 8.

Now, the one record that the virtual scale out analyzing unit 1021 selects in operation S5 is one record indicated by reference symbol P2 in FIG. 7, and this record is the second HTTP request 2. Therefore, in the case of FIG. 8 the virtual scale out analyzing unit 1021 stores the message of the second SQL request 2 as a message to transmit to the non-verified server in place of this record, which corresponds to the selected second HTTP request 2 (see reference symbol H_Req2 in FIG. 6), in the virtual scale out information storage unit 112.

The verification processing that the verification device 100 executes in the verification environment EV2 will be described in detail with reference to FIGS. 7, 8,10, 11, and 12.

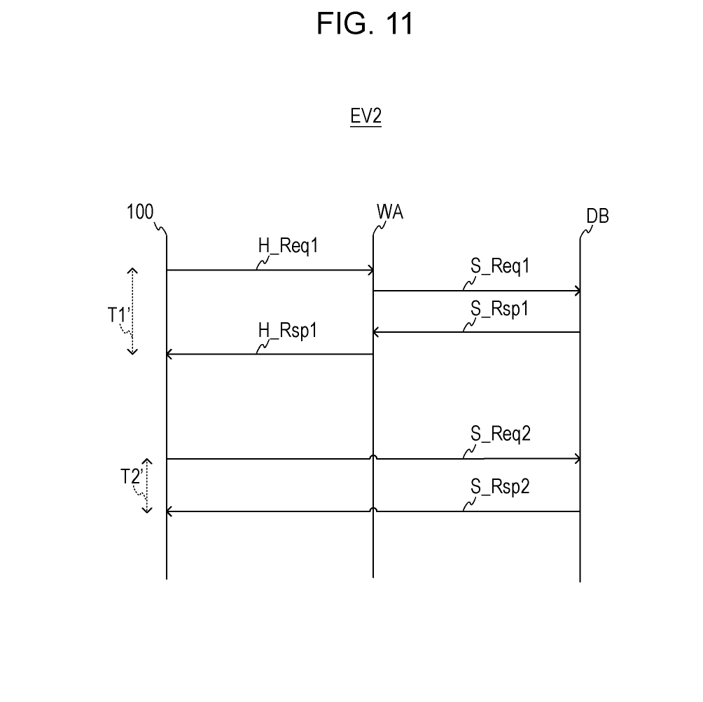

FIG. 11 is an example sequence diagram that schematically describes the flow of transmission/reception processing of a message in the verification environment EV2.

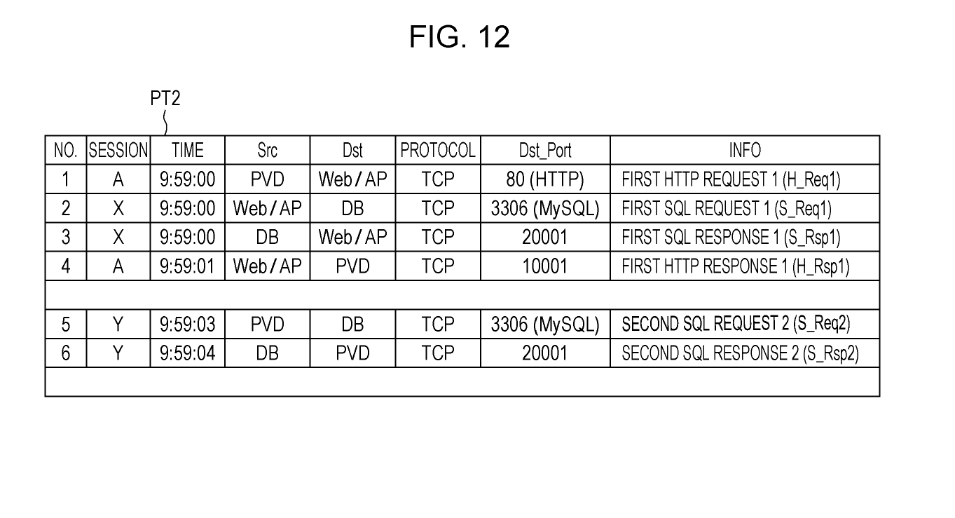

FIG. 12 is an example of a diagram illustrating a state in which content of a message that is captured by a verification performing unit 102 is stored in a table format. The verification performing unit 102 captures the messages transmitted/received in the verification environment EV2 in FIG. 3, and stores the content of the messages in the verification packet storage unit 113 in a table format. Specifically, the verification performing unit 102 stores the content of the captured message in the packet storage table PT2 in a time-series format.

In the description hereinafter, the records having session numbers 1 and 5 in the packet storage table PT1 in FIG. 7 are the first HTTP request 1 and second HTTP request 2 that are transmitted from the client terminal to the server to be verified, whereby these records are applicable to the verification request message Req{C→T} that is transmitted from the client terminal to the server to be verified.

Also, the record in session number 5 is the second HTTP request 2 selected in operation S5 in FIG. 9, whereby this record corresponds to the thinning out request message Req{C→T}′.

The records other than those having session numbers 1 and 5 are not applicable to the verification request message Req{C→T}, and similarly, the records other than those having session numbers 1 and 5 are not applicable to the thinning out request message Req{C→T}′.

Now, the server-to-be-verified virtual packet transmitting/receiving unit 1023 reads out one record at a time in ascending order of storage in the No. column in the packet storage table PT1 in FIG. 7 (operation S12 in FIG. 10). Now, first of all, the virtual scale out analyzing unit 1021 reads out the record having the session number 1, indicated by the reference symbol P1, from the packet storage table PT1. The record in session number 1 is not applicable to the thinning out request message Req{C→T}′, but corresponds to the verification request message Req{C→T}.

Accordingly, the server-to-be-verified virtual packet transmitting/receiving unit 1023 makes the determination of No in operation S13, and Yes in operation S16. The server-to-be-verified virtual packet transmitting/receiving unit 1023 then transmits the first HTTP request 1 to the AP server WA which is a server to be verified, as the verification request message Req{C→T} (operation S17). Reference the reverence symbol H_Req1 in FIG. 11 for transmission of the first HTTP request 1.

Thereafter, the server-to-be-verified virtual packet transmitting/receiving unit 1023 reads in the records in the session number 2 through session number 4, one record at a time. Session number 2 through session number 4 are not applicable to the verification request message Req{C→T}, nor to the thinning out request message Req{C→T}′, as described above. Accordingly, the server-to-be-verified virtual packet transmitting/receiving unit 1023 makes the determination of No in operation S13, and the determination of No in operation S16.

While the determination processing in operations S13 through S16 as to the records in session number 2 through session number 4 continue, the AP server WA executes the following processing. That is to say, upon receiving the first HTTP request 1 that is transmitted from the server-to-be-verified virtual packet transmitting/receiving unit 1023, the AP server WA responds to the received first HTTP request 1, and transmits the first SQL request 1 to the database DB, as indicated by the reference symbol S_Req1 in FIG. 11. The database DB transmits the first SQL response 1, which is a response to the first SQL request 1, to the AP server WA, as indicated by the reference symbol S_Rsp1 in FIG. 11.

Upon receiving the first SQL response 1, the AP server WA responds to the received first SQL response1, and transmits the first HTTP response 1 to the server-to-be-verified virtual packet transmitting/receiving unit 1023, as indicated by the reference symbol H_Rsp1.

The verification performing unit 102 captures the aforementioned messages transmitted/received between the verification device 100 and AP server WA and the messages transmitted/received between the AP server WA and the database DB, and stores these as a packet storage table PT2 in FIG. 12. The verification performing unit 102 stores the first HTTP request 1, first SQL request 1, first SQL response 1, and first HTTP response 1, as records indicated by session numbers 1, 2, 3, and 4, respectively, in the packet storage table PT2. Note that in the packet storage table PT2 in FIG. 12, “PVD” that is stored in the Src column and Dst column indicates the verification device 100.

Now, the server-to-be-verified virtual packet transmitting/receiving unit 1023 reads in the record having session number 5 as indicated by the reference symbol P2 in FIG. 7. The session number 5 corresponds to the thinning out request message Req{C→T}′.

Accordingly, the server-to-be-verified virtual packet transmitting/receiving unit 1023 makes the determination of Yes in operation S13, and extracts a request message Req{U→T}′ to be transmitted to the non-verified server in place of the thinning out request message Req{C→T}′, from the virtual scale out information storage unit 112 (operation S14). The request message Req{U→T}′ is the second SQL request 2.

The server-to-be-verified virtual packet transmitting/receiving unit 1023 transmits the second SQL request 2 to the non-verified server (database DB) in the verification environment EV2 (see reference symbol S_Req2 in FIG. 11).

Upon receiving the second SQL request 2 that is transmitted from the server-to-be-verified virtual packet transmitting/receiving unit 1023 of the verification device 100, the database DB responds to the second SQL request 2, and transmits the second SQL response 2 to the verification device 100 (see reference symbol S_Rsp2 in FIG. 11).

The verification performing unit 102 captures the aforementioned messages transmitted/received between the verification device 100 and the database DB, and stores these as the packet storage table PT2 in FIG. 12. The verification performing unit 102 stores the second SQL request 2 as the record indicated by session number 5, and the second SQL response 2 as the record indicated by the session number 6, in the packet storage table PT2.

As described above, the verification system described in FIG. 3 has a first device, second device, and verification device 100. The first device responds to each of a received first data group and second data group, and transmits a third data group and fourth data group. The second device receives the third data group and transmits the second data group.

The verification system has a first system and second system, each including a first device and second device.

The first system is the active environment EV1 in the example in FIG. 3, and the second system is the verification environment EV2.

The first device may be an AP server, for example. The second device may be a database, for example. Also, each of the first data group through fourth data group is a data group including one or more units of data.

The first data group may include the first HTTP request 1 and second HTTP request 2, for example. The second data group may include the first SQL response 1 and second SQL response 2, for example. The third data group may include the first SQL request 1 and second SQL request 2, for example, and the fourth data group may include the first HTTP response 1 and second HTTP response 2, for example.

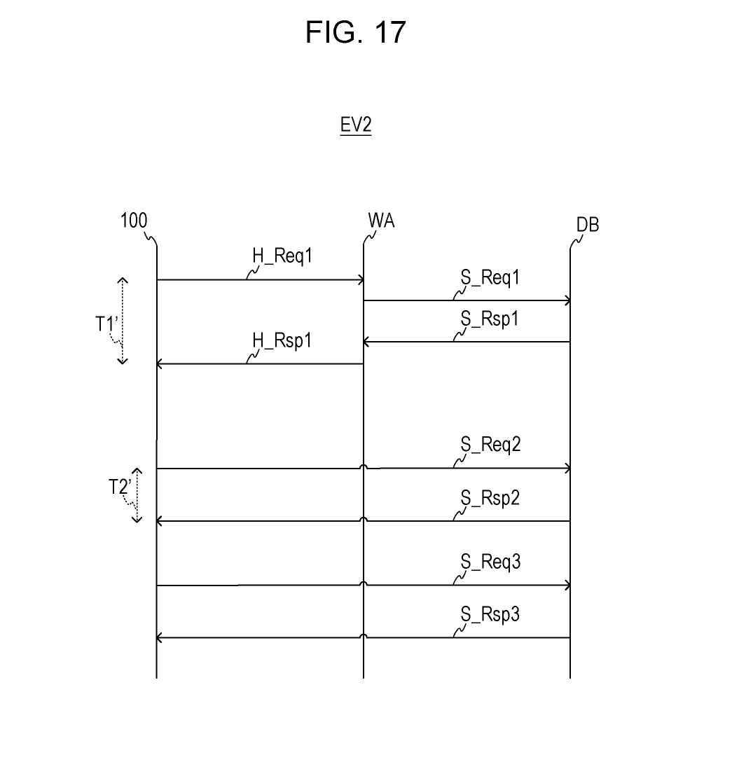

The server-to-be-verified virtual packet transmitting/receiving unit 1023 directly transmits a partial data group in the third data group that the database DB receives, to the database DB. In the first exemplary embodiment, the partial data group is the second SQL request 2 (see reference symbol S_Req2) in the case of FIG. 11. Also, in a second exemplary embodiment described later in detail, the partial data group is the second SQL request 2 (see reference symbol S_Req2) and the third SQL request3 (see reference symbol S_Req3) in the case of FIG. 17.

Also, the server-to-be-verified virtual packet transmitting/receiving unit 1023 transmits the first data group corresponding to another data group in the third data group to the AP server, thereby supplying another data group to the database DB. In the first exemplary embodiment and the later-described second exemplary embodiment, the other data group is the first SQL request 1 (see reference symbol S_Req1) in the case of FIGS. 11 and 17.

The first data group corresponding to this other data group is the first HTTP request 1 (see reference symbol H_Req1) which is the HTTP request serving as a trigger for the AP server to transmit this other data group. If the server-to-be-verified virtual packet transmitting/receiving unit 1023 transmits the first HTTP request 1 to the AP server, the AP server responds to the first HTTP request 1, and transmits the first SQL request 1 to the database DB. That is to say, the first SQL request 1 is supplied to the database DB.

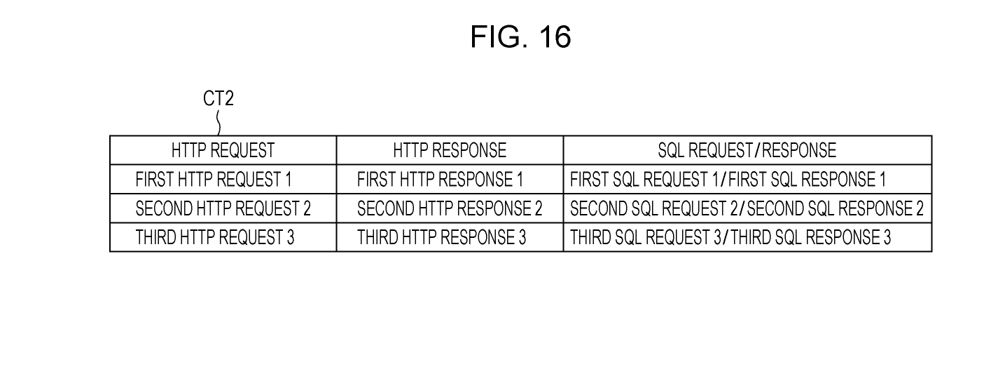

The verification device 100 further has a storage unit that stores corresponding information that is correlated with each of the first through fourth data groups that have been transmitted/received in the active environment EV1. This storage unit may be the storage device 13, for example. This corresponding information is information stored in a table that indicates the correlation of an HTTP request, an SQL request corresponding to this HTTP request, an SQL response corresponding to this SQL request, and an HTTP response corresponding to this SQL response. This table may be the correlation table CT1 in FIG. 8 and a later-described correlation table CT2 in FIG. 16, for example.

The server-to-be-verified virtual packet transmitting/receiving unit 1023 identifies the first data group to transmit to the AP server in the verification environment EV2 from the first data group in the active environment EV1, and identifies the partial data group from the third data group in the active environment EV1. The first data group and third data group in the active environment EV1 are the aforementioned corresponding information (correlation tables CT1 and CT2), and data groups that are stored in the packet storage table PT1 in FIG. 7.

The server-to-be-verified virtual packet transmitting/receiving unit 1023 performs the aforementioned identifying, based on the corresponding information, and the number of units in the case that the AP server is scaled out in the active environment EV1, that are input into the verification device 100. In the first exemplary embodiment, the server-to-be-verified virtual packet transmitting/receiving unit 1023 identifies one HTTP request from two HTTP requests which make up the first data group, from the aforementioned corresponding information. Also in the first exemplary embodiment, the server-to-be-verified virtual packet transmitting/receiving unit 1023 identifies the second SQL request 2 as the partial data group, from the third data group.

The request/response analyzing unit 1024 uses the first data group, partial data group, and fourth data group to perform operation verification. The request/response analyzing unit 1024 will be described in detail below.

Verification Results

Display processing of the verification results will be described with reference to FIGS. 6, 11, 12, and 13. FIG. 13 is an example method describing the flow of the display processing of the verification results.

Operation S21: The request/response analyzing unit 1024 determines whether the readout of all of the data stored in the active packet storage unit 111 has ended. In other words, the request/response analyzing unit 1024 determines whether or not the processing described with reference to FIG. 10 has ended.

Operation S22: The request/response analyzing unit 1024 determines whether or not the average response time in the active environment exceeds the average response time in the verification environment.

The average response time in the active environment will be described.

The request/response analyzing unit 1024 computes a first time period in the active environment EV1, by taking the total time from when the first data group is transmitted until when the fourth data group corresponding to the first data group is received at the client terminal, and dividing this by the number of units of the first data included in the first data group. This first period of time is the average response time in the active environment.

The number of units of the first data refers to the number of pieces of the first data included in the first data group. In the example above, the first data group includes two data units, which are the first HTTP request 1 and second HTTP request 2, whereby the number of units of the first data is 2. Also, the fourth data group corresponding to the first data group is the first HTTP response 1 and second HTTP response 2 in the above example.

In the example in FIG. 6, the sum total of the times indicated by the reference symbols T1 and T2 correspond to the aforementioned total time. Accordingly, in the example in FIG. 6, the first time is expressed with Expression (2) below.

Average response time of active system Avj=(T1+T2)/2 (2)

The request/response analyzing unit 1024 computes a total time Ta1 in the verification environment EV2, from when the first data group is transmitted to the AP server until the fourth data group corresponding to the first data group is received. The request/response analyzing unit 1024 then computes a total time Ta2 in the verification environment EV2, from when the partial data group identified in the database DB is transmitted until when the second data group corresponding to the partial data group is received.

The request/response analyzing unit 1024 then computes the sum total time of the total times Ta1 and Ta2. In the case of the example in FIG. 11, the total time Ta1 is a time indicated by a reference symbol T1′ and the total time Ta2 is a time indicated by a reference symbol T2′.

The request/response analyzing unit 1024 also computes a second time dividing the above sum total time by a sum total of the number of units of the first data included in the first data group and the number of units of the partial data included in the partial data group. This second time is the average response time in the verification environment.

In the case of the example in FIG. 11, the first data group includes one of the data units of the first HTTP request 1, whereby the number of units of the first data is 1. The partial data group includes one data unit of the second SQL request 2, whereby the number of units of the partial data is 1. Accordingly, in the example in FIG. 11, the second time is expressed by Expression (3).

Average response time in verification system Ave=(T1′+T2′)/2 (3)

The request/response analyzing unit 1024 stores the average response time in the active system Avj and the average response time in the verification system Ave in the test result storage unit 114.

In the case that the average response time in the active environment exceeds the average response time in the verification environment (Yes in Operation S22), the flow is advanced to operation S23.

Operation S23: The request/response analyzing unit 1024 determines that the scale out of the server to be verified is valid, and displays the determination results. In other words, the request/response analyzing unit 1024 determines that the number of AP servers to scale out is appropriate, and outputs the determination results.

Specifically, the request/response analyzing unit 1024 instructs the result display unit 103 to display these determination results. The result display unit 103 responds to the instructions, and displays the determination results on the display device DA.

Operation S24: The request/response analyzing unit 1024 determines whether or not a service level agreement (SLA) is specified for the average response time in the verification environment. This SLA corresponds to a predetermined threshold. The SLA is stored in the storage device 13 as time information (for example, in units of seconds). Specifically, in the case that time information is stored in the storage device as an SLA, the request/response analyzing unit 1024 determines that an SLA is specified for the average response time in the verification environment. In the case that an SLA is specified for the average response time in the verification environment (Yes in operation S24), the flow is advanced to operation S25.

Operation S25: The request/response analyzing unit 1024 determines whether to comply with the SLA of the average response time. In the case that the administrator has to comply with the SLA of the average response time, the administrator stores a flag to that effect in the storage device 13, having the flag turned on. On the other hand, in the case that the administrator does not have to comply with the SLA of the average response time, the administrator stores a flag to that effect in the storage device 13, having the flag turned off.

In the case that the request/response analyzing unit 1024 complies with the SLA of the average response time, that is, in the case that the flag is turn on (Yes in operation S25), the flow is advanced to operation S26.

Operation S26: The request/response analyzing unit 1024 displays information indicating that the number of servers to be verified that will be scaled out will be increased. Specifically, the request/response analyzing unit 1024 instructs the result display unit 103 to display this information. The result display unit 103 responds to these instructions and displays this information on the display device DA.

Now, in the case that the average response time in the active environment does not exceed the average response time of the verification environment (No in operation S22), the flow is advanced to operation S27.

Operation S27: The request/response analyzing unit 1024 determines that the scale out of the server to be verified is invalid, and displays the determination result. Specifically, the request/response analyzing unit 1024 instructs the result display unit 103 to display this determination result. The result display unit 103 responds to these instructions and displays the determination result on the display device DA.

In the case that an SLA is not specified for the average response time in the verification environment (No in operation S24), the processing is ended. Also, in the case of not complying with the SLA of the average response time, that is, in the case that the aforementioned flag is turned off (No in operation S25), the request/response analyzing unit 1024 ends the processing.

Thereafter, in the case that the verification device 100 displays a valid determination result on the display device DA, the administrator may think that the cause of performance degradation in the active environment exists in the server to be verified (for example, the AP server), and may actually increase the number of AP servers in the active environment.

On the other hand, in the case that the verification device 100 displays an invalid determination result on the display device DA, the administrator may think that the cause of performance degradation in the active environment exists other than the AP server, and may perform upgrade processing to improve the performance of the database DB, for example. Additionally, the administrator may increase the number of databases DB.

According to the verification device of the present embodiment, in the case that performance degradation is occurring in the active environment, the administrator may identify the cause of the performance degradation thereof without actually increasing the number of devices in the verification environment. Since the administrator does not actually perform a scale out in the verification environment, cost and parts for additional devices are not incurred. Additionally, since the administrator does not actually perform a scale out in the verification environment, setup and update work for the various types of devices such as the load balancer that accompany a scale out are not incurred.

Next, a second exemplary embodiment will be described. According to the first exemplary embodiment, a state wherein the number of servers to be verified is increased by one is created virtually. According to the second exemplary embodiment, a state wherein the number of servers to be verified is increased by two is created virtually.

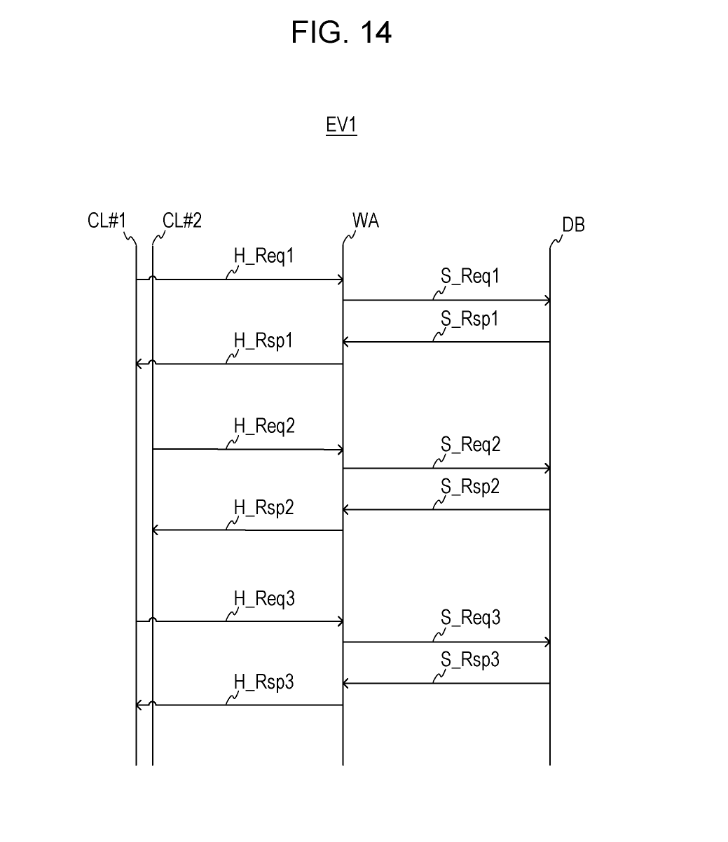

FIG. 14 is an example sequence diagram to schematically describe the flow of transmission/reception processing of messages in the active environment EV1.

The reference symbols H_Req1, S_Req1, S-Rsp1, H_Rsp1, H_Req2, S_Req2, S_Rsp2, and H_Rsp2 are the same as those in FIG. 6, so descriptions of the reference symbols will be omitted here. Also, the reference symbols H_Req3, S_Req3, S_Rsp3, and H_Rsp3 are the same as those in FIG. 1, so descriptions of the reference symbols will be omitted here.

As described in the first exemplary embodiment, the active packet capturing unit 1011 captures the messages described in reference to the sequence diagram in FIG. 14 in a time-series format, and stores these in the active packet storage unit 111.

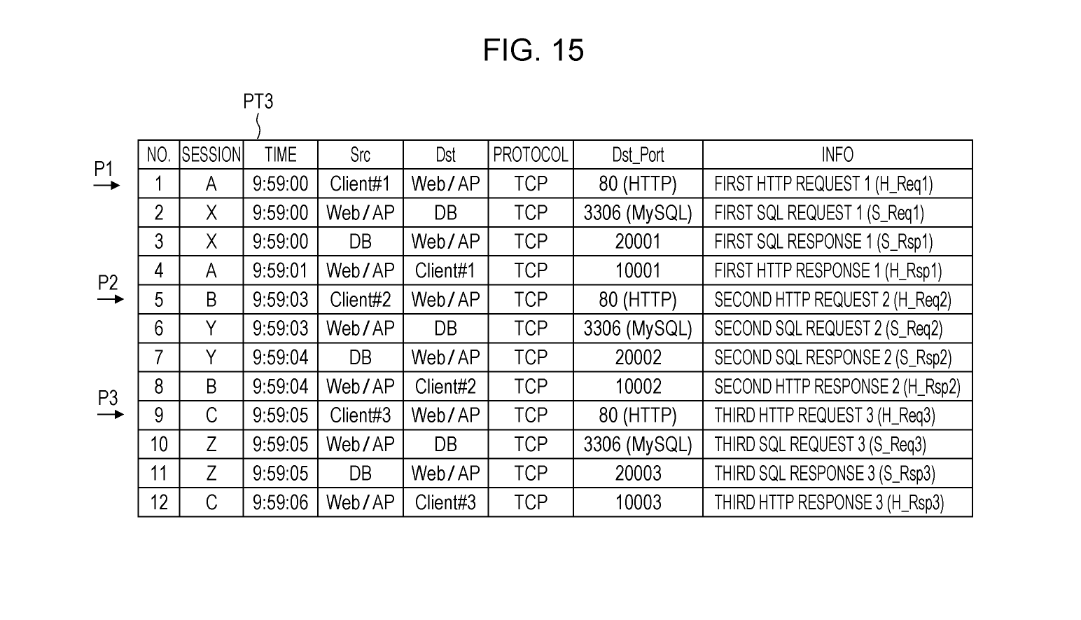

FIG. 15 is an example diagram illustrating a state in which content of a message that is captured by the actual packet capturing unit 1011 is stored in a table format. The content in the columns in FIG. 15 have been described with reference to FIG. 7, so description of this content will be omitted here.

Correlation Table

FIG. 16 is an example of a table indicating the correlation between an HTTP request, an SQL request corresponding to this HTTP request, an SQL response corresponding to this SQL request, and an HTTP response corresponding to this SQL response. For example, the system administrator may analyze the content in FIG. 15, create a correlation table CT2, and store this beforehand in the storage device 13.

The content in the first through third rows in the correlation table CT2 is the same as that in FIG. 8, so the description thereof will be omitted. The correlation table CT2 may store a third HTTP request 3 (see reference symbol H_Req3 in FIG. 14), a third HTTP response 3 (see reference symbol H_Rsp3 in FIG. 14), and a third SQL request 3-third SQL response 3 (see reference symbols S_Req3 and S_Rsp3 in FIG. 14) in the fourth row, for example.

Correction Processing Method Corresponding to Thinning Out Request Message

Storage processing for a correction processing method that corresponds to the thinning out request message in the second exemplary embodiment will be described with reference to FIGS. 9, 15, and 16.

The virtual scale out analyzing unit 1021 executes the processing described with reference to the method in FIG. 9 as to a packet storage table PT3 in FIG. 15, and in operation S4 in FIG. 9, executes selection processing as to the request message Req{C→T} stored in the storage device 13 (operation S5).

In the example above, the number of application servers in the AP server WA1 in the active environment EV1 is 1 server (Sb=1). Also, the number application servers in the AP server WA1 in the scaled out active environment EV1 is 3 servers (Sa=3). Also, the request messages Req{C→T} stored in the storage device 13 are the three records indicated by the reference symbols P1 through P3 in FIG. 15. That is to say, Rn=3.

In this case, Rd=2(((3−1)/3)×3). Accordingly, the virtual scale out analyzing unit 1021 selects two request messages Req{C→T}. That is to say, the virtual scale out analyzing unit 1021 selects two of the three records indicated by the reference symbols P1 through P3 In FIG. 15. For Sa, Sb, Rn, and Rd, see Expression (1) in the first exemplary embodiment.

The virtual scale out analyzing unit 1021 selects two records indicated by reference symbols P2 and P3, for example, and stores these in the virtual scale out information storage unit 112 (operation S5).

The virtual scale out analyzing unit 1021 stores the messages to be transmitted to a non-verified server (for example, database DB) in place of the selected two records (that is, thinning out HTTP request), based on FIG. 16. The virtual scale out analyzing unit 1021 stores the second SQL request 2 message which corresponds to the selected second HTTP request 2 (see reference symbol H_Req2 in FIG. 14) in the virtual scale out information storage unit 112, in the case of FIG. 16. Further, in the case of FIG. 16, the virtual scale out analyzing unit 1021 stores the third SQL request 3 message which corresponds to the selected third HTTP request 3 (see reference symbol H_Req3 in FIG. 14) in the virtual scale out information storage unit 112.

Verification Processing in Verification Environment

The verification processing that the verification device 100 executes in the verification environment EV2 will be described in detail with reference to FIG. 10 and FIGS. 15 through 18.

FIG. 17 is an example sequence diagram that schematically describes the flow of transmission/reception processing of messages in the verification environment EV2.

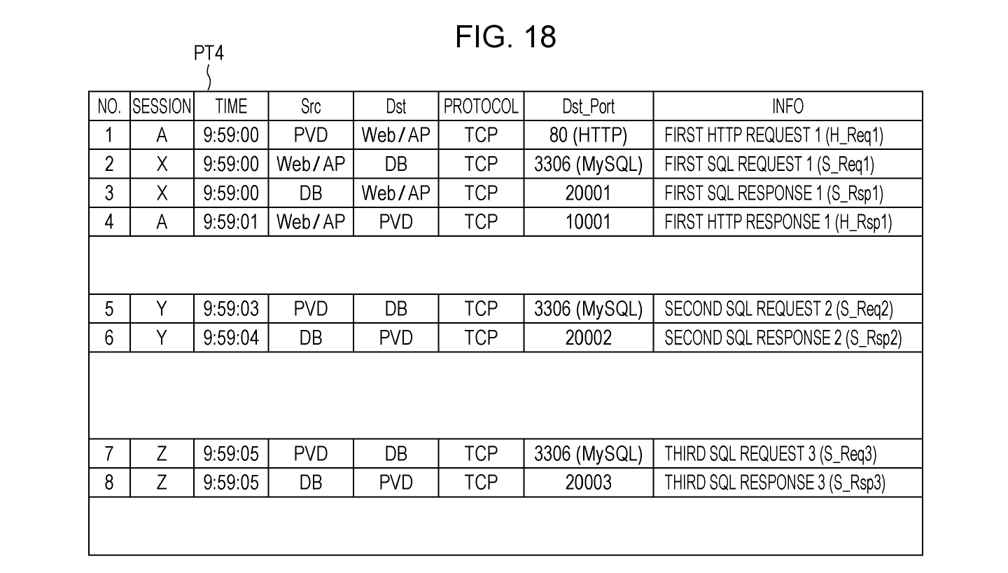

FIG. 18 is an example of a diagram illustrating a state in which content of a message that is captured by the verification performing unit 102 is stored in a table format. The verification performing unit 102 captures the messages transmitted/received in the verification environment EV2 in FIG. 3, and stores these in a packet storage table PT4 in a time-series format.

In the description below, the records in session numbers 1, 5, and 9, which are indicated by reference symbols P1, P2, and P3 in the packet storage table PT3 in FIG. 15, are the first HTTP requests 1, 2, and 3 that are transmitted from the client terminal to the server to be verified, whereby these records correspond to the verification request messages Req{C→T} that are transmitted from the client terminal to the server to be verified.

Also, the records in session numbers 5 and 9 are the second HTTP requests 2 and 3 that have been selected in operation 5 in FIG. 9, whereby these records correspond to the thinning out request messages Req{C→T}′.

The records having session numbers other than 1, 5, or 9 do not correspond to the verification request messages Req{C→T} nor to the thinning request messages Req{C→T}′.

Now, the server-to-be-verified virtual packet transmitting/receiving unit 1023 reads out one record at a time in ascending order of storage in the No. column in the packet storage table PT3 in FIG. 15 (operation S12). First of all, the virtual scale out analyzing unit 1021 reads out a record having a session number 1, indicated by the reference symbol P1 in FIG. 15, from the packet storage table PT3. The record having the session number 1 does not correspond to the thinning out request message Req{C→T}′ but does correspond to the verification request message Req{C→T}.

Accordingly, the server-to-be-verified virtual packet transmitting/receiving unit 1023 makes a determination of No in operation S13, and makes a determination of Yes in operation S16. The server-to-be-verified virtual packet transmitting/receiving unit 1023 then transmits the first HTTP request 1 to the AP server WA which is a server to be verified, as a verification request message Req{C→T} (operation S17). See the reference symbol H_Req1 in FIG. 17 regarding the transmission of this first HTTP request 1.

Thereafter, the server-to-be-verified virtual packet transmitting/receiving unit 1023 reads in the records having session numbers 2 through 4 in FIG. 15, one record at a time. As mentioned above, the session numbers 2 through 4 do not correspond to the verification request message Req{C→T} nor to the thinning out request message Req{C→T}′. Accordingly, the server-to-be-verified virtual packet transmitting/receiving unit 1023 makes the determination of No in operation S13, and makes the determination of No in operation S16.

While the determination processing in operations S13 through S16 as to the records in session number 2 through session number 4 in FIG. 15 continue, the AP server WA executes the following processing. That is to say, upon receiving the first HTTP request 1 that is transmitted from the server-to-be-verified virtual packet transmitting/receiving unit 1023, the AP server WA responds to the received first HTTP request 1, and transmits the first SQL request 1 to the database DB, as indicated by the reference symbol S_Req1 in FIG. 17. The database DB transmits the first SQL response 1, which is a response to the first SQL request 1, to the AP server WA, as indicated by the reference symbol S_Rsp1 in FIG. 17.

Upon receiving the first SQL response 1, the AP server WA responds to the received first SQL response1, and transmits the first HTTP response 1 to the server-to-be-verified virtual packet transmitting/receiving unit 1023, as indicated by the reference symbol H_Rsp1.

The verification performing unit 102 captures the aforementioned messages transmitted/received between the verification device 100 and AP server WA and the messages transmitted/received between the AP server WA and the database DB, and stores these as a packet storage table PT4 in FIG. 18. The verification performing unit 102 stores the first HTTP request 1, first SQL request 1, first SQL response 1, and first HTTP response 1, as records indicated by session numbers 1, 2, 3, and 4, respectively, in the packet storage table PT4. Note that in the packet storage table PT4 in FIG. 18, “PVD” that is stored in the Src column and Dst column indicates the verification device 100.

Now, the server-to-be-verified virtual packet transmitting/receiving unit 1023 reads in the record having session number 5 as indicated by the reference symbol P2 in FIG. 15. The session number 5 corresponds to the thinning out request message Req{C→T}′.

Accordingly, the server-to-be-verified virtual packet transmitting/receiving unit 1023 makes the determination of Yes in operation S13, and extracts a request message Req{U→T}′ to be transmitted to the non-verified server in place of the thinning out request message Req{C→T}′, from the virtual scale out information storage unit 112 (operation S14). The request message Req{U→T}′ is the second SQL request 2.

The server-to-be-verified virtual packet transmitting/receiving unit 1023 transmits the second SQL request 2 to the non-verified server (database DB) in the verification environment EV2 (see reference symbol S_Req2 in FIG. 17).

Upon receiving the second SQL request 2 that is transmitted from the server-to-be-verified virtual packet transmitting/receiving unit 1023, the database DB responds to the second SQL request 2, and transmits the second SQL response 2 to the verification device 100, indicated by the reference symbol S_Rsp2 in FIG. 17.

The verification performing unit 102 captures the aforementioned messages transmitted/received between the verification device 100 and the database DB, and stores these as the packet storage table PT4 in FIG. 18. The verification performing unit 102 stores the second SQL request 2 as the record indicated by session number 5, and the second SQL response 2 as the record indicated by the session number 6, in the packet storage table PT4.

The server-to-be-verified virtual packet transmitting/receiving unit 1023 reads in the record having the session number 9 indicated by the reference symbol P3 in FIG. 15. The session number 9 corresponds to the thinning out request message Req{C→T}′.

Accordingly, the server-to-be-verified virtual packet transmitting/receiving unit 1023 makes a determination of Yes in operation S13, and extracts the request message Req{U→T}′, which is to be transmitted to the non-verified server in place of the thinning out request message Req{C→T}′, from the virtual scale out information storage unit 112 (operation S14). The request message Req{U→T}′ is the third SQL request 3.

The server-to-be-verified virtual packet transmitting/receiving unit 1023 transmits the third SQL request 3 to the non-verified server (database DB) of the verification environment EV2 (see reference numeral S_Req3 in FIG. 17).

Upon receiving the third SQL request 3 that is transmitted from the server-to-be-verified virtual packet transmitting/receiving unit 1023, the database DB responds to the third SQL request 3 and transmits the third SQL response 3 which is indicated by the reference symbol S_Rsp3 in FIG. 17 to the verification device 100.

The verification performing unit 102 captures the messages transmitted/received between the verification device 100 and database DB, and stores these as the packet storage table PT4 in FIG. 18. The verification performing unit 102 stores the third SQL request 3 as a record indicated by a session number 7 in the packet storage table PT4, and stores the third SQL response 3 as a record indicated by a session number 8 therein.

The request/response analyzing unit 1024 executes processing described in FIG. 13, and determines whether a scale out of the server to be verified is valid or invalid.

Description will be given for another embodiment, exemplifying a case wherein the verification device virtually executes the same processing as the processing that the client terminal and non-verified server execute in an verification environment EV2, and verifies whether or not the scale out of the server to be verified is valid.

In the description below, the non-verified server is the database described according to the embodiment above, and the server to be verified is the application server described according to the embodiment above. Note that the processing that the verification device virtually executes in the verification environment EV2, which is the same processing as the processing that the client terminal and non-verified server execute, is disclosed in detail in Japanese Laid-open Patent Publication No. 2012-195699.

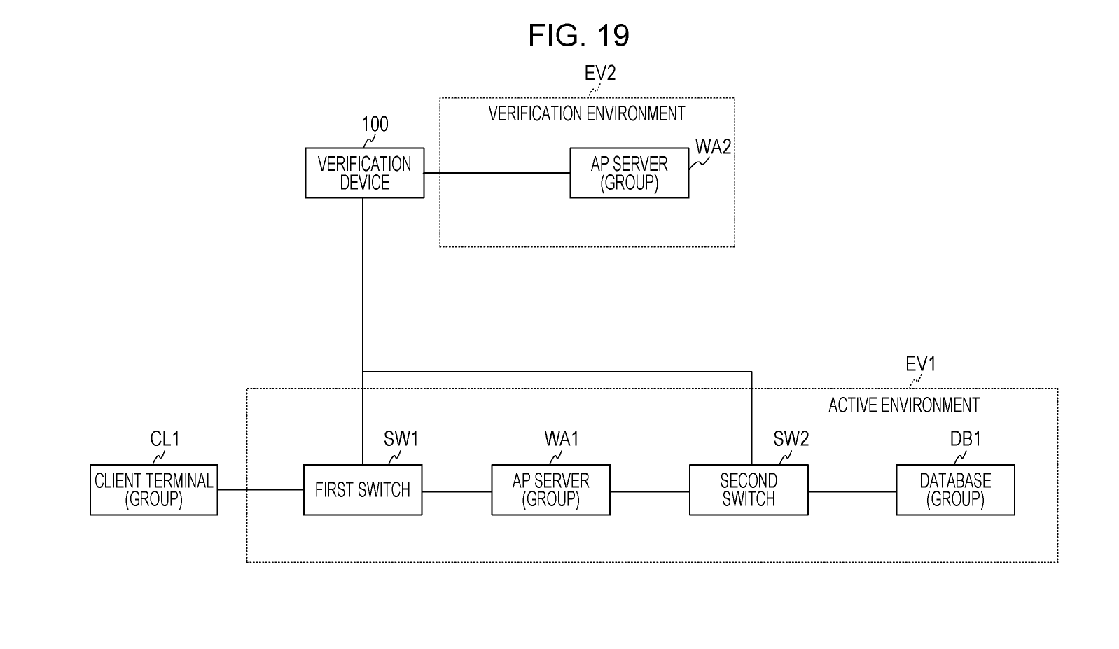

FIG. 19 is an example diagram to describe the entire system of another embodiment. A verification device 100 is connected to an active environment EV1 and a verification environment EV2. The active environment EV1 and a verification environment EV2 are separate networks from each other. The verification environment EV2 differs from the verification environment EV2 described according to the embodiment above, and provides an AP server WA2 but not a database DB2.

The verification device 100 virtually executes the same processing in the verification environment EV2 that the client terminal and non-verified server executes. The verification device 100 verifies whether or not the scale out of the server to be verified is valid.

Block Diagram of Software Modules

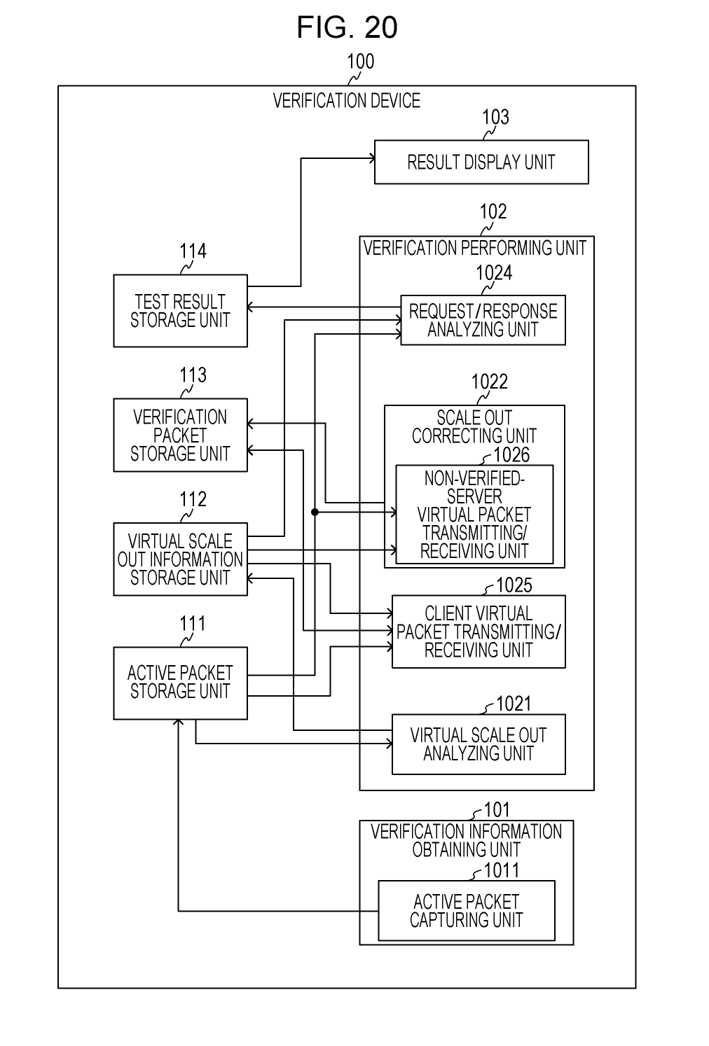

FIG. 20 is an example block diagram of software modules that the verification device 100 in FIG. 19 executes. The verification device 100 has a verification information obtaining unit 101, verification performing unit 102, result displaying unit 103, active packet storage unit 111, virtual scale out information storage unit 112, verification packet storage unit 113, and test result storage unit 114.

The CPU 11 in FIG. 4 reads out these programs from the storage device 13 at the time of startup, and causes these programs to function as a software module by loading these as a program 12a in the memory 12.

The verification performing unit 102 has a virtual scale out analyzing unit 1021, scale out correcting unit 1022, request/response analysis unit 1024, client virtual packet transmitting/receiving unit 1025, and non-verified server virtual packet transmitting/receiving unit 1026.

The client virtual packet transmitting/receiving unit 1025 performs processing to virtually execute the operations of the client terminal. The server to be verified virtual packet transmitting/receiving unit 1026 performs processing to virtually execute the operations of the non-verified server.

Message Capturing Processing in Active Environment

The message capturing processing in the active environment will be described with reference to FIGS. 14 and 15. Let us say that message transmitting/receiving is executed as described with reference to FIG. 14 according to the embodiment above, in the active environment EV1. The active packet capturing unit 1011 of the verification device 100 receives messages transmitted from the first switch SW1 and second switch SW2 as described according to the embodiment above, and stores the message content in the active packet storage unit 111 in a table format as illustrated in FIG. 15.

Correction Processing Method Corresponding to Thinning Out Request Message

The processing to store a correction processing method corresponding to the thinning out request message will be described in detail with reference to FIGS. 9, 15, and 16.

The virtual scale out analyzing unit 1021 selects the HTTP request to thin out, based on FIGS. 15 and 16, and stores a message to be transmitted in place of the HTTP request to thin out, based on FIGS. 15 and 16.

Now, the virtual scale out analyzing unit 1021 executes the processing described with reference to FIG. 9, repeats the processing in operations S1 through S4, and stores the records indicated by the reference symbols P1 through P3 in FIG. 15 in the storage device 13 (operation S4).

Upon the virtual scale out analyzing unit 1021 repeating the processing in operations S1 through S4, and the readout of all of the records in the packet storage table PT3 in FIG. 15 being ended (Yes in operation S1), the flow is advanced to operation S5.

The virtual scale out analyzing unit 1021 executes the processing described in the method in FIG. 9 as to the packet storage table PT3 in FIG. 15, and in operation S4 in FIG. 9 executes selection processing as to the request message Req{C→T} stored in the storage device 13 (operation S5).

In the example above, the number of application servers in the AP server WA1 in the active environment EV1 is 1 (Sb=1). Also, the number of application servers in the AP server WA1 in the active environment EV1 in the case of having been scaled out is 2 (Sa=2). Also, the request message Req{C→T} stored in the storage unit 13 are 3 records indicated by reference symbols P1 through P3 in FIG. 15. That is to say, Rn is 3.

In this case, Rd=1.5(((2−1)/2)×3). Rd is rounded down to integer, whereby Rd=1.

Accordingly, the virtual scale out analyzing unit 1021 selects one request message Req{C→T}. That is to say, the virtual scale out analyzing unit 1021 selects one of the 3 records indicated by the reference symbols P1 through P3 in FIG. 15. See the Expression (1) in the first exemplary embodiment for Sa, Sb, Rn, and Rd.

The virtual scale out analyzing unit 1021 may select the one record indicated by the reference symbol P2, for example, and store this in the virtual scale out information storage unit 112 (operation S4).

The virtual scale out analyzing unit 1021 stores a message to transmit to the non-verified server (for example, database DB) in place of the selected one record (that is, thinning out HTTP request), based on FIG. 16. In the case of FIG. 16, the virtual scale out analyzing unit 1021 stores the second SQL request 2 message, which corresponds to the selected second HTTP request 2 (see reference symbol H_Req2 in FIG. 14), in the virtual scale out information storage unit 112.

Verification Processing in Verification Environment

The verification processing in the verification environment EV2 that the verification device 100 executes will be described with reference to FIGS. 15, 16, 21, and 22.

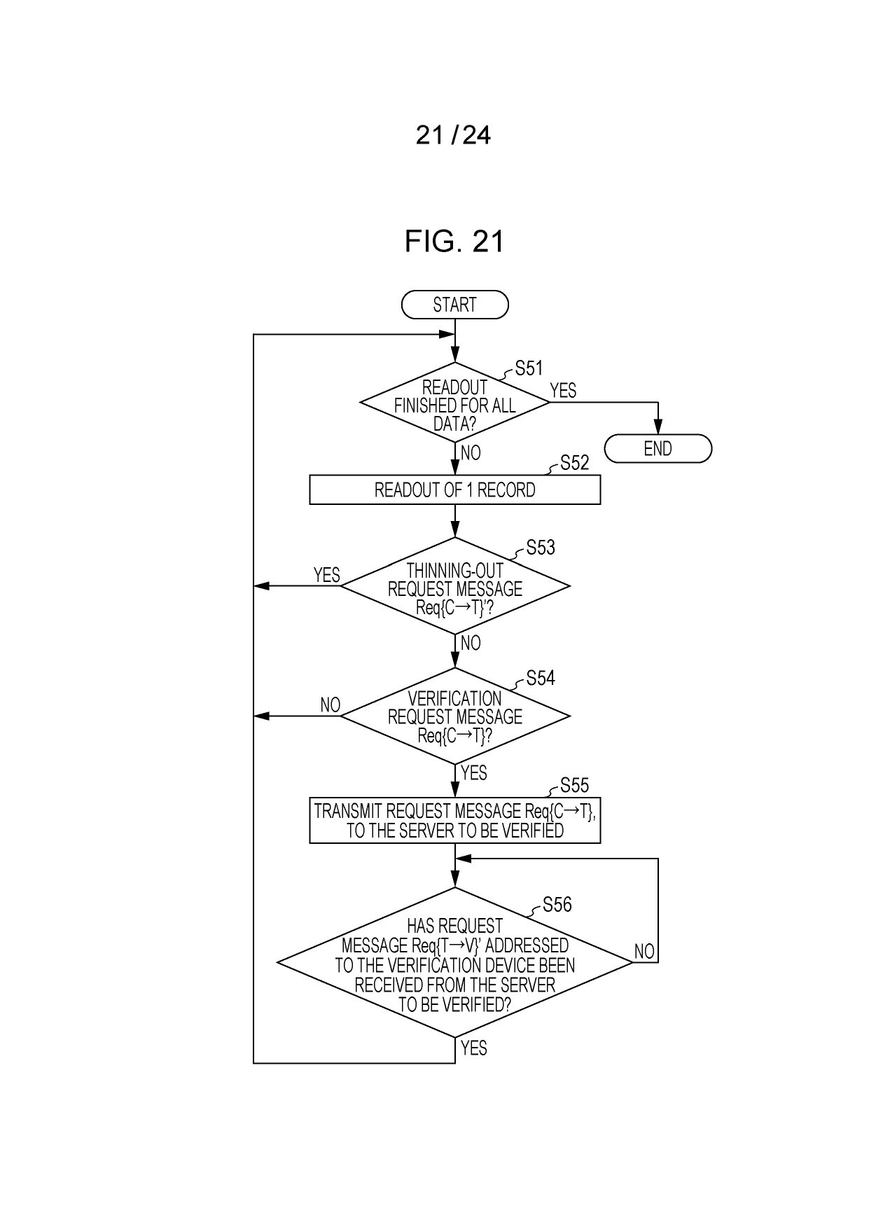

FIG. 21 is an example method to describe the flow of message transmission/reception processing in the verification environment EV2, which the client virtual packet transmitting/receiving unit 1025 executes.

Operation S51: The client virtual packet transmitting/receiving unit 1025 determines whether or not the readout of all of the data stored in the active packet storage unit 111 has ended. In the case that the readout of all of the data has ended (Yes in operation S51), the processing is ended. In the case that the readout of all of the data has not ended (No in operation S51), the flow is advanced to operation S52. Specifically, the client virtual packet transmitting/receiving unit 1025 determines whether or not all of the records in the packet storage table PT3 in FIG. 15 have been read out.

Operation S52: The client virtual packet transmitting/receiving unit 1025 reads out the records stored in the active packet storage unit 111, one row at a time. Specifically, the client virtual packet transmitting/receiving unit 1025 reads out one record at a time, in ascending order of storage in the No. column in the packet storage table PT3 in FIG. 15.

Operation S53: The client virtual packet transmitting/receiving unit 1025 determines whether or not the one record that is read out corresponds to the thinning out request message Req{C→T}′. The thinning out request message Req{C→T}′ is a request message that the verification scale out analyzing unit 1021 has stored in the virtual scale out information storage unit 112 in operation S5 in FIG. 9. In the case that the one record that is read out does not correspond to the thinning out request message Req{C→T}′ (No in operation S53), the flow is advanced to operation S54.

Operation S54: The client virtual packet transmitting/receiving unit 1025 determines whether or not the one record that is read out in operation S52 corresponds to the verification request message Req{C→T} that is transmitted from the client terminal to the server to be verified. In the case that the one record that is read out in operation S52 corresponds to the verification request message Req{C→T} that is transmitted from the client terminal to the server to be verified (Yes in operation S54), the flow is advanced to operation S55.

Operation S55: The client virtual packet transmitting/receiving unit 1025 transmits the verification request message Req{C→T} to the server to be verified.

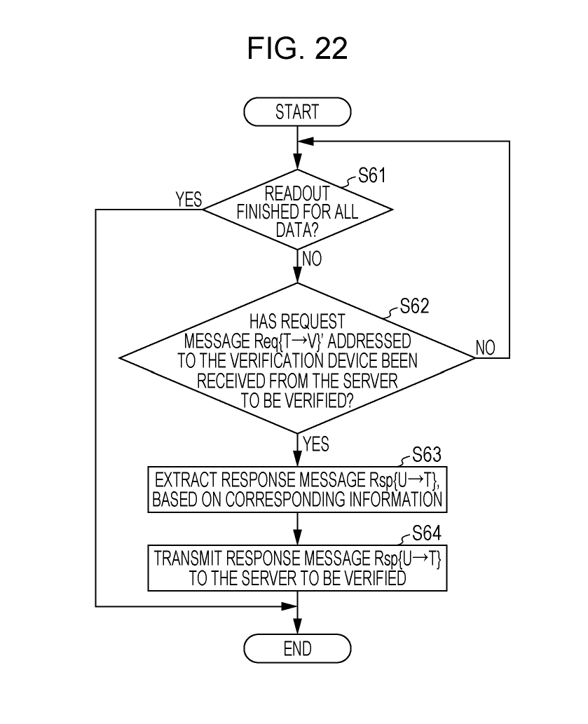

Operation S56: The client virtual packet transmitting/receiving unit 1025 determines whether or not the non-verified server virtual packet transmitting/receiving unit 1026 has received a request message Req{TV}′ addressed to the verification device 100 from the server to be verified and transmitted a response message Rsp{U→T} to the server to be verified. In other words, the client virtual packet transmitting/receiving unit 1025 determines whether or not the non-verified server virtual packet transmitting/receiving unit 1026 has ended the execution of a later-described operation S64 in FIG. 22. Note that “V” in the brackets { } indicates the verification device 100.

In the case that the non-verified server virtual packet transmitting/receiving unit 1026 receives a request message Req{T→V}′ addressed to the verification device from the server to be verified, and does not transmit a response message Rsp{U→T} to the server to be verified (No in operation S56), the client virtual packet transmitting/receiving unit 1025 continues the determination processing in operation S56.

In the case that the non-verified server virtual packet transmitting/receiving unit 1026 receives a request message Req{T→V}′ addressed to the verification device 100 from the server to be verified, and transmits a response message Rsp{U→T} to the server to be verified (Yes in operation S56), the flow is returned to operation S51.

Note that in the case that the one record that is read out corresponds to the thinning out request message Req{C→T}′ (Yes in operation S53), the flow is returned to operation S51. In the case that the one record read out in operation S52 does not correspond to the verification request message Req{C→T} that is transmitted from the client terminal to the server to be verified (No in operation S54), the flow is returned to operation S51.

FIG. 22 is an example method describing the flow of the message transmission/reception processing in the verification environment EV2 that the non-verified server virtual packet transmitting/receiving unit 1026 executes.

Operation S61: The non-verified server virtual packet transmitting/receiving unit 1026 determines whether or not the client virtual packet transmitting/receiving unit 1025 has ended the readout of all of the data described in operation S51 in FIG. 21. In the case that the readout of all of the data has ended (Yes in operation S61), the processing is ended. In the case that the readout of all of the data has not ended (No in operation S61), the flow is advanced to operation S62.

Operation S62: The non-verified server virtual packet transmitting/receiving unit 1026 determines whether or not a request message Req{T→V}′ addressed to the verification device 100 has been received from the server to be verified. In the case that a request message Req{TV}′ addressed to the verification device 100 has been received from the server to be verified (Yes in operation S62), the flow is advanced to operation S63.

Operation S63: The non-verified server virtual packet transmitting/receiving unit 1026 extracts a response message Rsp{U→T} to transmit to the server to be verified from the verification device 100, based on the correlation information table.

Operation S64: The non-verified server virtual packet transmitting/receiving unit 1026 transmits the response message Rsp{U→T} extracted in operation S63 to the server to be verified, as a response from the non-verified server to the server to be verified.

In the case that a request message Rsp{TU}′ addressed to the verification device 100 is not received from the server to be verified (No in operation S62), the flow is returned to operation S61.

The verification processing in a verification environment EV3 that the verification device 100 executes will be described in detail with reference to FIGS. 15, 16, and 21 through 24.

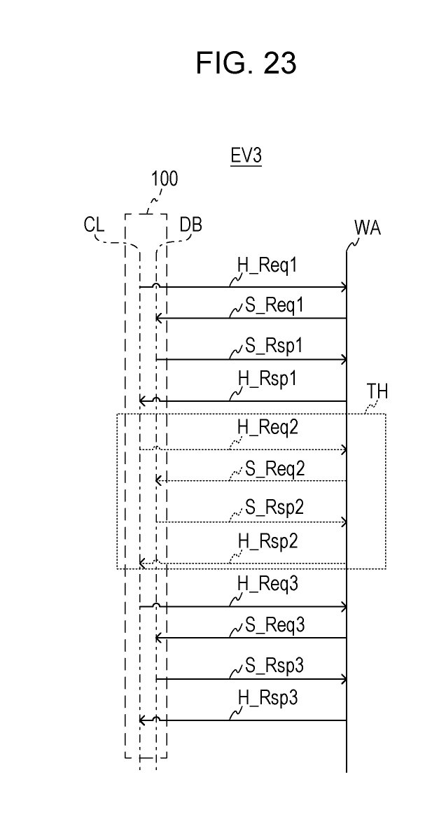

FIG. 23 is an example sequence diagram schematically describing the flow of message transmission/reception processing in the verification environment EV3. Note that the broken likes indicated by reference numeral 100 in FIG. 23 schematically illustrates a state wherein the verification device 100 virtually executes the processing content of the client device and database. Also, the dotted line frame indicated by the reference symbol TH schematically illustrates the message content that the verification device 100 thins out.

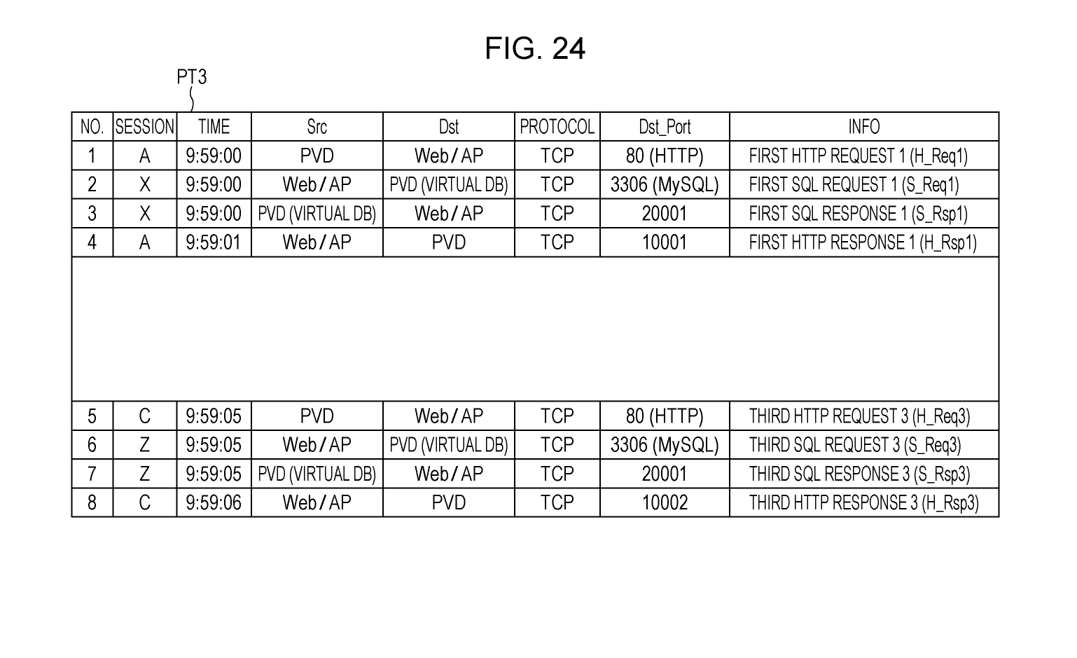

FIG. 24 is an example of a diagram illustrating a state in which content of a message that is captured by the verification performing unit 102 is stored in a table format. The verification performing unit 102 captures the message transmitted/received in the verification environment EV3 in FIG. 23, and stores the message content in the verification packet storage unit 113 in a table format. Specifically, the verification performing unit 102 stores the content of the captured message in a packet storage table PT6 in a time-series format.

The record having a session number 5 in FIG. 15 is the second HTTP request 2 selected in operation S5 in FIG. 9, whereby this record corresponds to the thinning out request message Req{C→T}′.

Now, the client virtual packet transmitting/receiving unit 1025 reads out one record at a time, in ascending order of storage in the No. column in the packet storage table PT3 in FIG. 15 (operation S52). First of all, the client virtual packet transmitting/receiving unit 1025 reads out a record having the session number 1 as indicated by the reference symbol P1, from the packet storage table PT1. The record in session number 1 does not correspond to the thinning out request message Req{C→T}′, but does correspond to the verification request message Req{C→T}.

Accordingly, the client virtual packet transmitting/receiving unit 1025 makes a determination of No in operation S53 and makes a determination of Yes in operation S54. The client virtual packet transmitting/receiving unit 1025 then transmits the first HTTP request 1 to the AP server WA which is the server to be verified, as a verification request message Req{C→T} (operation S55). For the transmission of the first HTTP request 1, see the reference symbol H_Req1 in FIG. 23.

Following this, the client virtual packet transmitting/receiving unit 1025 continues the determining processing in operation S56. During this continuation, the AP server WA1 responds to the first HTTP request 1, and transmits the first SQL request 1 to the verification device 100 (see reference symbol S_Req1 in FIG. 23).

The non-verified server virtual packet transmitting/receiving unit 1026 receives a first SQL request 1. The first SQL request 1 is a request message Req{TV}′ addressed to the verification device 100 from the AP server WA. Accordingly, the non-verified server virtual packet transmitting/receiving unit 1026 makes a determination of Yes in operation S62. The non-verified server virtual packet transmitting/receiving unit 1026 extracts the first SQL response 1, which is a response message Rsp{U→T} that corresponds to the first SQL request 1, based on the correlation table CT2 in FIG. 16 (operation S63).

The non-verified server virtual packet transmitting/receiving unit 1026 transmits the extracted first SQL response 1 to the AP server WA (operation S64). For the transmission of this first SQL response 1, see the reference symbol S_Rsp1 in FIG. 23.

During the time that the client virtual packet transmitting/receiving unit 1025 is continuing the determining processing in operation S56, the aforementioned transmission processing of the first SQL response 1 is ended. In other words, during the determining processing, the processing in operation S64 is ended. Consequently, a determination of Yes is made in operation S56 in FIG. 21, and the flow is returned to operation S51.

The records having session numbers 2 through 4 in FIG. 15 are not thinning out messages Req{C→T}′ and are not verification request messages Req{C→T}. Accordingly, upon reading out the record having the session number 2, the client virtual packet transmitting/receiving unit 1025 makes a determination of No in operations S53 and S54, and the flow is returned to operation S51. Also, upon reading out the record having the session number 3, the client virtual packet transmitting/receiving unit 1025 makes a determination of No in operations S53 and S54. Also, upon reading out the record having the session number 4, the client virtual packet transmitting/receiving unit 1025 makes a determination of No in operations S53 and S54.

The AP server WA having received the first HTTP request 1 transmits the first HTTP response 1 to the verification device 100 during the readout of the records having session numbers 2 through 4 and the record determining processing (see reference symbol H_Rsp1 in FIG. 23).

As described above with the session numbers 1 through 4 in FIG. 15 and the reference symbols H_Req1, S_Req1, S_Rsp1, and H_Rsp1 in FIG. 23, the verification device 100 virtually executes the operations of the client terminal and database.

The record having the session number 5 in FIG. 15 is a thinning out request message Req{C→T}′. On the other hand, the records having session numbers 6 through 8 are not thinning out request messages Req{C→T}′ and are not verification request messages Req{C→T}.

Accordingly, upon reading out the record having the session number 5, the client virtual packet transmitting/receiving unit 1025 makes a determination of Yes in operation S53, and the flow is returned to operation S51. Also, upon reading out the record having the session number 6, the client virtual packet transmitting/receiving unit 1025 makes a determination of No in operations S53 and S54. Also, upon reading out the record having the session number 7, the client virtual packet transmitting/receiving unit 1025 makes a determination of No in operations S53 and S54. Also, upon reading out the record having the session number 8, the client virtual packet transmitting/receiving unit 1025 makes a determination of No in operations S53 and S54.

During the reading out of the aforementioned records having session numbers 5 through 8 in FIG. 15 and the determining processing of the records, the client virtual packet transmitting/receiving unit 1025 does not transmit a message to the AP server WA. Also, the AP server WA does not transmit a message to the verification device 100.

The dotted line arrows within the dotted line frame indicated by the reference symbol TH indicate a state wherein the client virtual packet transmitting/receiving unit 1025 does not transmit a message to the AP server WA and a state wherein the AP server WA does not transmit a message to the verification device 100.

The record having a session number 9 in FIG. 15 does not correspond to the thinning out request message Req{C→T}′, but does correspond to the verification request message Req{C→T}.

Accordingly, the client virtual packet transmitting/receiving unit 1025 makes a determination of No in operation S53, and makes a determination of Yes in operation S54. The client virtual packet transmitting/receiving unit 1025 transmits the third HTTP request 3 to the AP server WA which is a server to be verified, as a verification request message Req{C→T} (operation S55). For the transmission of this third SQL response 3, see the reference symbol S_Req3 in FIG. 23.

Following this, the client virtual packet transmitting/receiving unit 1025 continues the determining processing in operation S56. During this continuation, the AP server WA1 responds to the third HTTP request 3, and transmits the third SQL request 3 to the verification device 100 (see reference symbol S_Req3 in FIG. 23).

The non-verified server virtual packet transmitting/receiving unit 1026 receives a third SQL request 3. The third SQL request 3 is a request message Req{T→V}′ addressed to the verification device 100 from the AP server WA. Accordingly, the non-verified server virtual packet transmitting/receiving unit 1026 makes a determination of Yes in operation S62. The non-verified server virtual packet transmitting/receiving unit 1026 extracts the third SQL response 3, which is a response message Rsp{U→T} that corresponds to the third SQL request 3, based on the correlation table CT2 in FIG. 16 (operation S63).

The non-verified server virtual packet transmitting/receiving unit 1026 transmits the extracted third SQL response 3 to the AP server WA (operation S64). For the transmission of this third SQL response 3, see the reference symbol S_Rsp3 in FIG. 23.

During the time that the client virtual packet transmitting/receiving unit 1025 is continuing the determining processing in operation S56, the aforementioned transmission processing of the third SQL response 3 is ended. In other words, during the determining processing, the processing in operation S64 is ended.

The records having session numbers 10 through 12 are not thinning out request messages Req{C→T}′ and are not verification request messages Req{C→T}. Accordingly, upon reading out the record having the session number 10, the client virtual packet transmitting/receiving unit 1025 makes a determination of No in operations S53 and S54, and the flow is returned to operation S51. Also, upon reading out the record having the session number 11, the client virtual packet transmitting/receiving unit 1025 makes a determination of No in operations S53 and S54. Also, upon reading out the record having the session number 12, the client virtual packet transmitting/receiving unit 1025 makes a determination of No in operations S53 and S54.

During the readouts of the records having session numbers 10 through 12 and the determining processing of the records, the AP server WA having received the third SQL response 3 transmits the third HTTP response 3 to the verification device 100 (see reference symbol H_Rsp3 in FIG. 23).

The verification performing unit 102 captures the messages transmitted/received between the verification device 100 and AP server WA, and stores these as a packet storage table PT6 in FIG. 24. The verification performing unit 102 stores the first HTTP request 1, first SQL request 1, first SQL response 1, and first HTTP response 1 as records having session numbers 1, 2, 3, and 4, respectively, in the packet storage table PT6. Also, the verification performing unit 102 stores the third HTTP request 3, third SQL request 3, third SQL response 3, and third HTTP response 3 as records having session numbers 5, 6, 7, and 8, respectively, in the packet storage table PT6.

As described above, the non-verification server virtual packet transmitting/receiving unit 1026 transmits a first data group to the AP server in the verification environment EV2, responds to the received first data group, and identifies a second data group corresponding to the third data group that the AP server transmitted, based on corresponding information. The corresponding information may be the correlation tables CT1 and CT2 described according to the embodiment above, for example.

In the example in FIG. 23, the first data group may be the first HTTP request 1 (reference symbol H_Req1) through the third HTTP request 3 (reference symbol H_Req3). Also, the third data group that the AP server transmitted, in response to the first data group, is the first SQL request 1 (reference symbol S_Req1) through the third SQL request 3 (reference symbol S_Req3). Also, the second data group corresponding to the third data group is the first SQL response 1 (reference symbol S_Rsp1) through the third SQL response 3 (reference symbol S_Rsp3).

The non-verification server virtual packet transmitting/receiving unit 1026 transmits the identified second data group to the AP server, responds to the received second data group, and receives the fourth data group that the AP server has transmitted.

In the example in FIG. 23, the fourth data group is the first HTTP response 1 (reference symbol H_Rsp1) through third HTTP response 3 (reference symbol H_Rsp3).

The non-verification server virtual packet transmitting/receiving unit 1026 transmits a partial data group in the first data group which is subject to transmission to the AP server in the verification environment EV3, and does not transmit the other data groups in the first data group to the AP server.

In the example in FIG. 23, the first data group that is subject to transmission to the AP server in the verification environment EV3 may be the first HTTP request 1 (reference symbol H_Req1) through third HTTP request 3 (reference symbol H_Req3). A partial data group is the first HTTP request 1 (reference symbol H_Req1) and the third HTTP request 3 (reference symbol H_Req3). Also, another data group is the second HTTP request 2 (reference symbol H_Req2).

The non-verification server virtual packet transmitting/receiving unit 1026 identifies a portion of the first data group, based on the corresponding information and the number of AP servers in the active environment EV1 input into the verification device 100 in the case of scaling out the AP server. The partial identification of the first data group is described in detail according to the first and second exemplary embodiments and other embodiments above, so description thereof will be omitted here.

The request/response analyzing unit 1024 uses the first data group and fourth data group in the active environment EV1 and the verification environment EV3 to perform operation verification.

Specifically, the request/response analyzing unit 1024 computes a first time period in the active environment EV1, by taking the total time from when the first data group is transmitted until when the fourth data group corresponding to the first data group is received, and dividing this by the number of units of the first data included in the first data group.

The request/response analyzing unit 1024 computes a second time period in the verification environment EV3, by taking the total time from when the first data group is transmitted to the AP server until when the fourth data group corresponding to the first data group is received, and dividing this by the number of units of the first data included in the first data group. Note that the computing methods for computing the first and second time periods are described in detail with reference to FIG. 13, so description thereof will be omitted here.

The request/response analyzing unit 1024 determines that the number of AP server units to scale out the AP server is appropriate if the first time exceeds the second time, and outputs the determination results.

According to the verification device of the present embodiment, processing that is the same processing as that executed by the client terminal and the non-verified server are virtually executed, and verification is made as to whether or not the scale out of the server to be verified is valid. Therefore, a non-verified server (for example, database DB) does not have to be provided in the verification environment, since the same device is provided as in the active environment. Consequently, cost and parts for additional devices may be reduced.

Of the processing described according to the first and other embodiment, all or a portion thereof described as performing manually may be performed automatically with a common method.

For example, the verification device 100 analyzes the content in the packet storage table T1 in FIG. 7, and extracts an HTTP request, an SQL request corresponding to this HTTP request, an SQL response corresponding to this SQL response, and an HTTP response corresponding to this SQL response. The verification device 100 correlates the extracted HTTP request, HTTP response, SQL request, and SQL response, and stores these in the correlation table CT1 in FIG. 8.

All or a portion of the verification device may be functionally or physically distributed or summarized in optional increments, according to various types of load or usage situations or the like.

Additional Notes.

Note 8. A verification method executed in a verification system including a first system having a server configured to correspond to each of a received first data group and second data group, and to transmit a third data group and fourth data group, and a database configured to receive the third data group and transmit the second data group, a second system having the server, and a verification device configured to perform operation verification of the server or database in the first system, the method comprising: transmitting, by the verification device, the first data group to the server in the second system; responding to the received first data group identifying the second data group corresponding to the third data group transmitted by the server, based on corresponding information that correlate to each of the first, second, third, and fourth data groups that are transmitted and received in the first system; transmitting the identified second data group to the server; responding to the received second data group and receives the fourth data group transmitted by the server; and performing operation verification using the first data group and fourth data group in the first system and second system.

Note 9. A verification device configured to perform operation verification of a server that responds to each of received first data group and a second data group, and transmits a third data group and fourth data group, or of a database that receives the third data group and transmits the second data group, verification device comprising: a processor configured to perform the operation verification by transmitting, to the database, a partial data group in the third data group received by the database, transmitting, to the server, the first data group corresponding to another data group in the third data group, thereby supplying the other data group to the database, and performing operation verification using the first data group, partial data group, and fourth data group.

Note 10. A verification device of a verification system including a first system which includes a server configured to transmit a third data group and fourth data group corresponding to each of the received first data group and second data group, and to receive the third data group and transmit the second data group, and a second system including the server, configured to perform operation verification of the server or the database in the first system, the verification device comprising: a storage unit configured to store corresponding information correlated to each of the first, second, third, and fourth data groups that are transmitted and received in the first system; and a processor configured to transmit the first data group to the server in the second system, respond to the received first data group and identify a second data group corresponding to the third data group transmitted by the server based on the corresponding information, transmit the identified second data group to the server, and respond to the received second data group and receive the fourth data group which the server has transmitted; wherein the processor is configured to transmit a partial data group in the first data group which is subject to transmitting to the server in the second system, and performs operation verification, using the first data group and the fourth data group in the first system and the second system, without transmitting the other data group in the first data group to the server.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A verification system, comprising:
a server configured to receive each of a first data group and second data group, and transmit a third data group and a fourth data group to respond to each of the first data group and second data group received;
a database server configured to receive the third data group and transmit the second data group; and
a verification device configured to perform operation verification of the server or database server, the verification device including
a processor configured to transmit, to the database server, a partial data group in the third data group received by the database server, and transmit, to the server, the first data group corresponding to another data group in the third data group, thereby supplying the other data group to the database server and using the first data group, the partial data group, and the fourth data group, to perform the operation verification.

2. The verification system according to claim 1, further comprising:
a first system and a second system having the server and the database server,
wherein the verification device further includes
a storage configured to store corresponding information correlated to each of the first, second, third, and fourth data groups which are transmitted and received in the first system,
and wherein the processor is configured to identify, from the first data group in the first system, a first data group corresponding to another data group in the third data group, which is transmitted to the server in the second system, and identifies the partial data group from the third data group in the first system, based on the response information and the number of servers in the case of scaling out in the first system that has been input to the verification device.

3. The verification system according to claim 2,
wherein the processor is configured to, in the first system, computes
a first time period, by taking the total time from when the first data group is transmitted until when the fourth data group corresponding to the first data group is received, and dividing this by the number of units of the first data included in the first data group,
and in the second system, computes
a second time period, by taking the sum total time of the total time from when the first data group is transmitted to the server until the fourth data group corresponding to the first data group is received, and the total time from when the identified partial data group is transmitted to the database server until the second data group corresponding to the partial data group is received in the second system, and dividing the sum total time by the total of the number of units of the first data included in the first data group and the number of units of the partial data included in the partial data group,
and wherein in the operation verification, determines, in a case where the first time period exceeds the second time period, the number of the servers in the case of scaling out is appropriate, and outputs determination results.

4. A verification system, comprising:
a first system having a server configured to correspond to each of a received first data group and second data group, and to transmit a third data group and fourth data group, and a database server configured to receive the third data group and transmit the second data group;
a second system having the server; and
a verification device configured to perform operation verification of the server or database server in the first system,
wherein the verification device further includes
a storage unit configured to store corresponding information correlated to each of the first, second, third, and fourth data groups that are transmitted and received in the first system;
a processor configured to transmit the first data group to the server in the second system, respond to the received first data group and identify a second data group corresponding to the third data group transmitted by the server based on the response information, transmit the identified second data group to the server, and respond to the received second data group and receive the fourth data group which the server has transmitted;
and wherein the processor is configured to
transmit to the server a partial data group in the first data group which is subject to transmitting to the server in the second system; and
perform the operation verification, using the first data group and the fourth data group in the first system and the second system, without transmitting the other data group in the first data group to the server.

5. The verification system according to claim 4,
wherein the processor is configured to identify a portion of the first data group, based on the corresponding information and the number of devices in the case of scaling out the server in the first system input into the verification device.

6. The verification system according to claim 5,
wherein the processor is configured to, in the first system, compute
a first time period, by taking the total time from when the first data group is transmitted until when the fourth data group corresponding to the first data group is received, and dividing this by the number of units of the first data included in the first data group,
and in the second system, computes
a second time period, by taking the total time from when the first data group is transmitted to the server until the fourth data group corresponding to the first data group is received, and dividing this by the number of units of the first data included in the first data group,
and wherein in the operation verification, determines, in a case where the first time period exceeds the second time period, the number of the servers in the case of scaling out is determined to be appropriate, and outputs determination results.

7. A verification method executed in a verification system including a server configured to receive each of a received first data group and second data group, and transmit a third data group and a fourth data group, a database server configured to receive the third data group and transmit the second data group, and a verification device configured to perform operation verification of the server or database server, the method comprising:
transmitting, by the verification device, to the database server, a partial data group in the third data group received by the database server;
transmitting, to the server, the first data group corresponding to another data group in the third data group, to supply the other data group to the database server; and
performing the operation verification using the first data group, partial data group, and fourth data group.
